(19) United States
(12) Patent Application Publication
(10) Pub. No.: US 2011/0228537 A1
(43) Pub. Date: Sep. 22, 2011

(54) Adjustable Beam Size Illumination Optical Apparatus and Beam Size Adjusting Method

(75) Inventors: Keiko YOSHIMIZU, Yokohama-shi (JP); Hiroshi Aoyama, Ebina-shi (JP); Shigenobu Maruyama, Yokohama-shi (JP); Yasuhiro Yoshitake, Yokohama-shi (JP)

(73) Assignee: Hitachi Via Mechanics, Ltd., Ebina-shi (JP)

(21) Appl. No.: 13/049,089

(22) Filed: Mar. 16, 2011

(30) Foreign Application Priority Data
Mar. 17, 2010 (JP) 2010-060970
Mar. 17, 2010 (JP) 2010-061063
Mar. 17, 2010 (JP) 2010-061068
Feb. 14, 2011 (JP) 2011-028936

(51) Int. Cl. F21V 5/04

(52) U.S. Cl. 362/268

(57) ABSTRACT

An adjustable beam size illumination optical apparatus includes a beam size adjusting optical system which includes groups of cylindrical array lenses disposed correspondingly to the long and short axis directions respectively and having variable intervals among the lenses, and a group of cylindrical telescope lenses disposed correspondingly to one of the long and short axis directions and having variable intervals among the lenses, and adjusts parallel light from a light source in size in accordance with the two axis directions orthogonal to each other. The lens interval of one of the cylindrical array lens groups and the cylindrical telescope lens group is changed to adjust a beam size on a projection surface in accordance with the long axis direction or the short axis direction. Thus, it is possible to adjust the beam size in accordance with the long axis direction and the short axis direction individually, and it is possible to make irradiation with the beam with uniform intensity.

### BACKGROUND OF THE INVENTION

1. Field of the Invention

The present invention relates to an adjustable beam size illumination optical apparatus which includes an adjustable beam size illumination optical system for adjusting a beam size in a long axis direction and a short axis direction individually, and a beam size adjusting method to be carried out in the apparatus.

2. Description of the Background Art

To meet the future trend of printed board wiring which will be made finer, a laser machining apparatus which has been heretofore applied to drilling is also required to be applied to wiring pattern grooving. In the apparatus, a circuit pattern on a mask is imaged on a substrate by a projection lens, and the substrate is stage-scanned with slit illumination light, with which the substrate is machined directly. In the apparatus, a short-wavelength light source is used as a light source in consideration of machinability.

Since semiconductor chips have various shapes, there are a wide variety of package substrates to be mounted with the semiconductor chips. On the other hand, due to high running cost of the short-wavelength light source used as a light source, there is a request to use incident energy unwastefully. The energy can be used effectually if both the long-axis-direction size and the short-axis-direction size of a beam can be varied. The long-axis-direction beam size is varied to be adjusted to various package sizes. The short-axis-direction beam size is varied to expand the slit width in the scanning direction to thereby increase accumulation of the quantity of light and improve the machining speed.

FIGS. 31A and 31B are explanatory views showing the relation between a package size and a beam in the background art. FIGS. 32A and 32B are views showing the beam intensity of the beam in FIGS. 31A and 31B. In the background art, an optical system is constructed only correspondingly to one kind of package size (projection surface) 9 as shown in FIG. 31A. Assume that a rectangular beam 90 has a beam size 91 in the long axis direction and a beam size 92 in the short axis direction correspondingly to the package size 9. In this case, the sizes 91 and 92 are determined uniquely, but the long-axis-direction and short-axis-direction beam sizes cannot be changed independently. Accordingly, when the package is changed to a size designated by the reference numeral 9′ in FIG. 31B so that its long-axis-direction size is reduced, the long-axis-direction beam size 91 cannot follow the changed shape of the package in the background art as shown in the right part of FIG. 31A although the long-axis-direction and short-axis-direction beam sizes 91 and 92 should be also changed to long-axis-direction and short-axis-direction sizes 91′ and 92′ respectively correspondingly to the package size 9′ as shown in FIG. 31B. As shown in right part of FIG. 31A, in prior art, beam size of long-axis-direction 90 can't follow to the changed shape.

On the other hand, package machining always requires one and the same condition (one and the same intensity) 99 to reduce a variation in machining, as well as always uniform intensity distributions 93 and 94, as shown in FIG. 32A corresponding to the left part of FIG. 31A. To this end, the long-axis-direction and short-axis-direction beam sizes 91 and 92 are changed to the long-axis-direction and short-axis-direction beam sizes 91′ and 92′ respectively as shown in FIG. 31B when the package size 9 is changed to the package size 9′ as shown in the right part of FIG. 31A. As a result, machining can be made with uniform intensity distributions 93′ and 94′ and one and the same condition (one and the same intensity) 99′ as shown in FIG. 32B.

On the other hand, in an exposure apparatus, for the purpose of higher resolution, less light quantity loss, etc., the imaging magnification of a zoom optical system is changed to change the size of a secondary light source image and change the aperture angle of illumination light with respect to a mask surface. Such optical systems are disclosed in JP-A-3-170379, JP-A-5-234848, JP-A-10-270312, JP-A-2000-150374, JP-A-2003-86503, and JP-A-2005-79470. In addition, JP-A-63-153514 discloses an optical system in which in order to machine two rectangular to-be-machined places separated from each other, a beam is divided into two and at the same time varied in widthwise and lengthwise beam diameters by a triangular prism.

According to the optical systems disclosed in Japanese Patent Application No. 3-170374, JP-A-5-234848, JP-A-10-270312, Japanese Patent No. 2000-150374, JP-A-2003-86503, and JP-A-2005-79470, the size of the secondary light source image can be indeed changed, but the beam size on the projection surface cannot be changed desirably. On the other hand, according to the invention disclosed in JP-A-63-153514, it is difficult to obtain uniform intensity on the projection surface because the number of light sources is only one. Further, according to JP-A-63-153514, laser light may be nonuniform because the projection surface is irradiated with the laser light obliquely.

### SUMMARY OF THE INVENTION

Therefore, an object of the invention is to make long-axis-direction and short-axis-direction beam sizes variable independently of each other and achieve irradiation with a beam with uniform intensity.

In addition, another object of the invention is to control a beam size on a to-be-machined portion and an illumination size on an entrance pupil plane independently to thereby adjust the taper (resolution) of a machined section. The taper of the machined section depends on the illumination size on the entrance pupil plane.

In order to achieve the foregoing objects, according to a first configuration of the invention, there is provided an adjustable beam size illumination optical apparatus including: a light source which generates parallel light; a beam size adjusting optical system which includes lenses or lens groups disposed correspondingly to a long axis direction and a short axis direction respectively and having fixed or variable intervals among the lenses, and adjusts the parallel light from the light source in size in accordance with the two axis directions orthogonal to each other; a condenser lens by which a plurality of pieces of light from secondary light source images formed by the lenses or the lens groups are condensed and superposed on an irradiated surface; a field lens by which secondary light source images formed from the parallel light from the light source are reshaped on an entrance pupil plane of a projection lens; and a projection surface on which an image of the irradiated surface is formed by the field lens; wherein: the adjustable beam size optical system changes one of the lens intervals among the lenses or the lens groups to adjust a beam size on the projection surface in accordance with the long axis direction or the short axis direction.

In this case, the adjustable beam size illumination optical apparatus may include a light source size adjusting optical system which includes a collimator lens group disposed on an optical path of the parallel light to adjust the light source in size in accordance with the long axis direction and the short axis direction independently of each other while adjusting the parallel light from the light source in size in accordance with the two axis directions orthogonal to each other; wherein: the light source size adjusting optical system uses the collimator lens group to change an aperture angle of illumination light with respect to a mask surface to adjust an illumination size in an entrance pupil plane of the projection lens in accordance with the long axis direction and the short axis direction individually.

According to a second configuration of the invention, there is provided an adjustable beam size illumination optical apparatus including: a light source which generates parallel light; a beam size adjusting optical system which includes groups of cylindrical array lenses disposed correspondingly to a long axis direction and a short axis direction respectively and having a variable interval between adjacent ones of the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; a field lens by which secondary light source images formed from the parallel light from the light source are reshaped on an entrance pupil plane of a projection lens; and a projection surface on which an image of the irradiated surface is formed by the field lens; wherein: the beam size adjusting optical system changes the lens interval of one of the cylindrical array lens groups and the cylindrical telescope lens group to adjust a beam size on the projection surface in accordance with the long axis direction or the short axis direction.

In this case, of the cylindrical array lens groups, a cylindrical array lens group in a direction in which the beam size can be changed may include at least two cylindrical array lenses, and a cylindrical array lens group in a direction in which the beam size cannot be changed may include at least one cylindrical array lens.

According to a third configuration of the invention, there is provided an adjustable beam size illumination optical apparatus including: a light source which generates parallel light; a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other; a beam size adjusting optical system which includes groups of cylindrical array lenses disposed correspondingly to the long axis direction and the short axis direction respectively and having variable intervals among the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; a field lens by which secondary light source images formed from the parallel light from the light source are reshaped on an entrance pupil plane of a projection lens; and a projection surface on which an image of the irradiated surface is formed by the field lens; wherein: the light source size adjusting optical system uses the collimator lens group to adjust the light source in size to adjust an illumination size in the entrance pupil plane of the projection lens in accordance with the long axis direction and the short axis direction individually; and the beam size adjusting optical system changes the lens interval of one of the cylindrical array lens groups and the cylindrical telescope lens group to adjust a beam size on the projection surface in accordance with the long axis direction or the short axis direction.

The collimator lens group may include three or more collimator lenses in each of the long axis direction and the short axis direction so that the lens intervals can be changed to make the light source variable in size in accordance with the long axis direction and the short axis direction independently of each other. Alternatively, the collimator lens group may include two or more fixed collimator lenses in each of the long axis direction and the short axis direction so as to optimize the light source in size to use the light source in a fixed size.

According to a fourth configuration of the invention, there is provided an adjustable beam size illumination optical apparatus including: a light source which forms parallel light; a beam size adjusting optical system which includes groups of cylindrical array lenses disposed correspondingly to a long axis direction and a short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; a field lens by which secondary light source images formed from the parallel light from the light source are reshaped on an entrance pupil plane of a projection lens; and a projection surface on which an image of the irradiated surface is formed by the field lens; wherein: the beam size adjusting optical system changes the lens interval of one of the cylindrical array lens groups to adjust a beam size on the projection surface in accordance with the long axis direction or the short axis direction.

In this case, the beam size adjusting optical system may include a cylindrical array lens group for changing the beam size in the long axis direction, and a cylindrical array lens group for changing the beam size in the short axis direction; and each of the cylindrical array lens groups for changing the beam size in the long axis direction and the short axis direction respectively may include two or three cylindrical array lenses.

According to a fifth configuration of the invention, there is provided an adjustable beam size illumination optical apparatus including: a light source which generates parallel light; a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other; a beam size adjusting optical system which includes groups of cylindrical array lenses disposed correspondingly to the long axis direction and the short axis direction respectively and having variable intervals between adjacent ones of the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; a field lens by which secondary light source images formed from the parallel light emitted from the light source are reshaped on an entrance pupil plane of a projection lens; and a projection surface on which an image of the irradiated surface is formed by the field lens; wherein: the light source size adjusting optical system uses the collimator lens group to adjust the light source in size to adjust an illumination size in the entrance pupil plane of the projection lens in accordance with the long axis direction and the short axis direction individually; and the beam size adjusting optical system changes the lens interval of one of the cylindrical array lens groups to adjust a beam size on the projection surface in accordance with the long axis direction or the short axis direction.

The collimator lens group may include three or more collimator lenses in each of the long axis direction and the short axis direction so that the lens intervals can be changed to make the light source variable in size in accordance with the long axis direction and the short axis direction independently of each other. Alternatively, the collimator lens group may include two or more fixed collimator lenses in each of the long axis direction and the short axis direction so as to optimize the light source in size to use the light source in a fixed size.

According to a sixth configuration of the invention, there is provided an adjustable beam size illumination optical apparatus including: a light source which forms parallel light; a beam size adjusting optical system which includes groups of cylindrical array lenses disposed correspondingly to a long axis direction and a short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; a field lens by which secondary light source images formed from the parallel light from the light source are reshaped on an entrance pupil plane of a projection lens; and a projection surface on which an image of the irradiated surface is formed by the field lens; wherein: the beam size adjusting optical system changes the lens interval of one of the cylindrical telescope lens groups to adjust a beam size on the projection surface in accordance with the long axis direction or the short axis direction.

In this case, the cylindrical telescope lens groups may include three cylindrical telescope lenses in the long axis direction and the short axis direction respectively and the cylindrical array lens groups may include one or more cylindrical array lenses in the long axis direction and the short axis direction respectively.

According to a seventh configuration of the invention, there is provided an adjustable beam size illumination optical apparatus including: a light source which generates parallel light; a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other; a beam size adjusting optical system which includes groups of cylindrical array lenses disposed correspondingly to the long axis direction and the short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; a field lens by which secondary light source images formed from the parallel light from the light source are reshaped on an entrance pupil plane of a projection lens; and a projection surface on which an image of the irradiated surface is formed by the field lens; wherein: the light source size adjusting optical system uses the collimator lens group to adjust the light source in size to adjust an illumination size in the entrance pupil plane of the projection lens in accordance with the long axis direction and the short axis direction individually; and the beam size adjusting optical system changes the lens interval of one of the cylindrical telescope lens groups to adjust a beam size on the projection surface in accordance with the long axis direction or the short axis direction.

The collimator lens group may include three or more collimator lenses in each of the long axis direction and the short axis direction so that the lens intervals can be changed to make the light source variable in size in accordance with the long axis direction and the short axis direction independently of each other. Alternatively, the collimator lens group may include two or more fixed collimator lenses in each of the long axis direction and the short axis direction so as to optimize the light source in size to use the light source in a fixed size.

According to an eighth configuration of the invention, there is provided a beam size adjusting method in an illumination optical apparatus including: a light source which generates parallel light; a beam size adjusting optical system which includes lenses or lens groups disposed correspondingly to a long axis direction and a short axis direction respectively and having fixed or variable intervals among the lenses, and adjusts the parallel light from the light source in size in accordance with the two axis directions orthogonal to each other; a condenser lens by which a plurality of pieces of light from secondary light source images formed by the lenses or the lens groups are condensed and superposed on an irradiated surface; and a field lens by which secondary light source images formed from the parallel light from the light source are reshaped on an entrance pupil plane of a projection lens; the beam size adjusting method including the step of: changing the lens intervals of the lenses or the lens groups to change an aperture angle of illumination light with respect to the entrance pupil plane of the projection lens so that a beam size of light projected on the projection surface where an image of the irradiated surface is formed can be changed in accordance with the long axis direction and the short axis direction individually.

In this case, the illumination optical apparatus may further include a light source size adjusting optical system which includes a collimator lens group disposed on an optical path of the parallel light to adjust the light source in size in accordance with the long axis direction and the short axis direction independently of each other while adjusting the parallel light from the light source in size in accordance with the two axis directions orthogonal to each other. The beam size adjusting method includes the step of: allowing the light source size adjusting optical system to use the collimator lens group to change an aperture angle of illumination light with respect to a mask surface to adjust an illumination size in the entrance pupil plane of the projection lens in accordance with the long axis direction and the short axis direction individually.

According to a ninth configuration of the invention, there is provided a beam size adjusting method in an illumination optical apparatus including: a light source which generates parallel light; a beam size adjusting optical system which includes groups of cylindrical array lenses disposed correspondingly to a long axis direction and a short axis direction respectively and having variable intervals among the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; and a field lens by which secondary light source images formed from the parallel light from the light source are reshaped on an entrance pupil plane of a projection lens; the beam size adjusting method including the step of: changing the lens interval of one of the cylindrical array lens groups and the cylindrical telescope lens group to change an aperture angle of illumination light with respect to the entrance pupil plane of the projection lens so that a beam size of light projected on the projection surface where an image of the irradiated surface is formed can be changed in accordance with the long axis direction or the short axis direction.

According to a tenth configuration of the invention, there is provided a beam size adjusting method in an illumination optical apparatus including: a light source which generates parallel light; a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other; a beam size adjusting optical system which includes groups of cylindrical array lenses disposed correspondingly to the long axis direction and the short axis direction respectively and having variable intervals among the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; and a field lens by which secondary light source images formed from the parallel light from the light source are reshaped on an entrance pupil plane of a projection lens; the beam size adjusting method including the steps of: allowing the light source size adjusting optical system to use the collimator lens group to change an aperture angle of illumination light with respect to a mask surface so as to adjust an illumination size in the entrance pupil plane of the projection lens in accordance with the long axis direction and the short axis direction individually; and allowing the beam size adjusting optical system to change the lens interval of one of the cylindrical array lens groups and the cylindrical telescope lens group to change the aperture angle of the illumination light with respect to the entrance pupil plane of the projection lens so that a beam size of light projected on the projection surface where an image of the irradiated surface is formed is changed in accordance with the long axis direction or the short axis direction.

According to an eleventh configuration of the invention, there is provided a beam size adjusting method in an illumination optical apparatus including: a light source which generates parallel light; a beam size adjusting optical system which includes groups of cylindrical array lenses disposed correspondingly to a long axis direction and a short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; and a field lens by which secondary light source images formed from the parallel light from the light source are reshaped on an entrance pupil plane of a projection lens; the beam size adjusting method including the step of: changing one of the lens intervals of the cylindrical array lens groups to change an aperture angle of illumination light with respect to the entrance pupil plane of the projection lens so that a beam size of light projected on the projection surface where an image of the irradiated surface is formed is changed in accordance with the long axis direction or the short axis direction.

According to a twelfth configuration of the invention, there is provided a beam size adjusting method in an illumination optical apparatus including: a light source which generates parallel light; a light source size adjusting optical system which includes a collimator lens group disposed on an optical path of the parallel light to adjusting the light source in size in accordance with a long axis direction and a short axis direction independently of each other while adjusting the parallel light from the light source in size in accordance with the two axis directions orthogonal to each other; a beam size adjusting optical system which includes groups of cylindrical array lenses disposed correspondingly to the long axis direction and the short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; and a field lens by which secondary light source images formed from the parallel light from the light source are reshaped on an entrance pupil plane of a projection lens; the beam size adjusting method including the steps of: allowing the light source size adjusting optical system to use the collimator lens group to change an aperture angle of illumination light with respect to a mask surface so as to adjust an illumination size in the entrance pupil plane of the projection lens in accordance with the long axis direction and the short axis direction individually; and allowing the beam size adjusting optical system to change the lens interval of one of the cylindrical array lens groups to change the aperture angle of the illumination light with respect to the entrance pupil plane of the projection lens so that a beam size of light projected on the projection surface where an image of the irradiated surface is formed is changed in accordance with the long axis direction or the short axis direction.

According to a thirteenth configuration of the invention, there is provided a beam size adjusting method in an illumination optical apparatus including: a light source which generates parallel light; a beam size adjusting optical system which includes groups of cylindrical array lenses disposed correspondingly to a long axis direction and a short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; and a field lens by which secondary light source images formed from the parallel light from the light source are reshaped on an entrance pupil plane of a projection lens; the beam size adjusting method including the step of: changing the lens interval of one of the cylindrical telescope lens groups to change an aperture angle of illumination light with respect to the entrance pupil plane of the projection lens so that a beam size of light projected on the projection surface where an image of the irradiated surface is formed can be changed in accordance with the long axis direction or the short axis direction.

According to a fourteenth configuration of the invention, there is provided a beam size adjusting method in an illumination optical apparatus including: a light source which generates parallel light; a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other; a beam size adjusting optical system which includes groups of cylindrical array lenses disposed correspondingly to the long axis direction and the short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other; a condenser lens by which a plurality of pieces of light from secondary light source images formed by the cylindrical array lens groups are condensed and superposed on an irradiated surface; and a field lens by which secondary light source images formed from the parallel light from the light source are reshaped on an entrance pupil plane of a projection lens; the beam size adjusting method including the steps of: allowing the light source size adjusting optical system to use the collimator lens group to change an aperture angle of illumination light with respect to a mask surface so as to adjust an illumination size in the entrance pupil plane of the projection lens in accordance with the long axis direction and the short axis direction individually; and allowing the beam size adjusting optical system to change the lens interval of one of the cylindrical telescope lens groups to change the aperture angle of the illumination light with respect to the entrance pupil plane of the projection lens so that a beam size of light projected on the projection surface where an image of the irradiated surface is formed is changed in accordance with the long axis direction or the short axis direction.

In an embodiment which will be described later, the light source corresponds to the reference numeral 1; the cylindrical array lens groups, 10a, 10b, 10b′, 10c, 10d, 10d′, 20a, 20a′, 20b, 20c, 20c′, 20d, 50a, 60a, 70a, 80a, 90a, 100a, 110a, 120a, 170a, 180a, 210a, 220a, 250a, 260a, 290a and 300a; the cylindrical telescope lens groups, 30a, 30a′, 30c, 30c′, 40b, 40b′, 40d, 40d′, 150a, 150a′, 160a, 160a′, 190a, 190a′, 200a, 200a′, 230a, 230a′, 240a, 240a′, 270a, 270a′, 280a, 280a′, 310a and 310a′; the irradiated surface, 6; the condenser lens, 4; the entrance pupil plane, 7; the field lens, 5; and the projection surface, 9.

According to the invention, only if the lens interval of one of the cylindrical array lens group and the cylindrical telescope lens group is changed, the beam size on the projection surface can be changed in the long axis direction or the short axis direction individually. In addition, the beam size on the machined portion and the illumination size on the entrance pupil plane can be controlled independently of each other.

### BRIEF DESCRIPTION OF THE DRAWINGS

FIGS. 1A and 1B are explanatory views for explaining principles for adjusting a beam size according to the invention;

FIG. 2 is a view showing marginal rays from secondary light source images to an irradiated surface;

FIG. 3 is a view showing three short-axis-direction cylindrical telescope lenses;

FIGS. 4A and 4B are explanatory views showing an adjustable beam size illumination optical system according to Example 1 of the invention;

FIGS. 5A and 5B are views showing examples in which aperture angles φx and φy are changed to adjust the beam size in Example 1, respectively;

FIGS. 6A and 6B are explanatory views showing an adjustable beam size illumination optical system according to Example 2 of the invention;

FIGS. 7A and 7B are explanatory views showing an adjustable beam size illumination optical system according to Example 3 of the invention;

FIGS. 8A and 8B are explanatory views showing an adjustable beam size illumination optical system according to Example 4 of the invention;

FIGS. 9A and 9B are explanatory views showing an adjustable beam size illumination optical system according to Example 5 of the invention;

FIGS. 10A and 10B are views showing examples in which aperture angles φx and φy are changed to adjust the beam size in Example 5, respectively;

FIGS. 11A and 11B are explanatory views showing an adjustable beam size illumination optical system according to Example 6 of the invention;

FIGS. 12A and 12B are views showing examples in which aperture angles φx and φy are changed to adjust the beam size in Example 6, respectively;

FIGS. 13A and 13B are explanatory views showing an adjustable beam size illumination optical system according to Example 7 of the invention;

FIGS. 14A and 14B are views showing examples in which aperture angles φx and φy are changed to adjust the beam size in Example 7, respectively;

FIGS. 15A and 15B are explanatory views showing an adjustable beam size illumination optical system according to Example 8 of the invention;

FIGS. 16A and 16B are views showing examples in which aperture angles φx and φy are changed to adjust the beam size in Example 8, respectively;

FIGS. 17A and 17B are explanatory views showing an adjustable beam size illumination optical system according to Example 9 of the invention;

FIGS. 18A and 18B are views showing examples in which aperture angles φx and φy are changed to adjust the beam size in Example 9, respectively;

FIGS. 19A and 19B are explanatory views showing an adjustable beam size illumination optical system according to Example 10 of the invention;

FIGS. 20A and 20B are views showing examples in which aperture angles φx and φy are changed to adjust the beam size in Example 10, respectively;

FIGS. 21A and 21B are explanatory views showing an adjustable beam size illumination optical system according to Example 11 of the invention;

FIGS. 22A and 22B are views showing examples in which aperture angles φx and φy are changed to adjust the beam size in Example 11, respectively;

FIGS. 23A and 23B are explanatory views showing an adjustable beam size illumination optical system according to Example 12 of the invention;

FIGS. 24A and 24B are views showing examples in which aperture angles φx and φy are changed to adjust the beam size in Example 12, respectively;

FIGS. 25A and 25B are explanatory views (YZ section) showing an illumination size in an entrance pupil plane when the beam size is changed in Example 13 of the invention;

FIGS. 26A and 26B are explanatory views (XZ section) showing the illumination size in the entrance pupil plane when the beam size is changed in Example 13 of the invention;

FIG. 27 is an explanatory views (YZ section) showing a short-axis-direction illumination size adjusting optical system in the entrance pupil in Example 13 of the invention (low resolving power);

FIG. 28 is an explanatory views (YZ section) showing the short-axis-direction illumination size adjusting illumination optical system in the entrance pupil in Example 13 of the invention (high resolving power);

FIG. 29 is an explanatory views (XZ section) showing a long-axis-direction illumination size adjusting illumination optical system in the entrance pupil in Example 13 of the invention (low resolving power);

FIG. 30 is an explanatory views (XZ section) showing the long-axis-direction illumination size adjusting illumination optical system in the entrance pupil in Example 13 of the invention (high resolving power);

FIGS. 31A and 31B are explanatory views showing the relation between a package size and a beam in the background art, FIG. 31A showing a beam size in the case where the beam size is fixed uniquely as in the background art, FIG. 31B showing a beam size in the case where the beam size can be changed in the long axis direction and the short axis direction by a beam size adjusting optical system intended by the invention; and

FIGS. 32A and 32B are views showing the relation between the beam size and the intensity distribution of the beam in FIGS. 31A and 31B.

### DETAILED DESCRIPTION OF THE INVENTION

In description about an embodiment of the invention, principles for adjusting a beam size to be carried out in the invention will be described first.

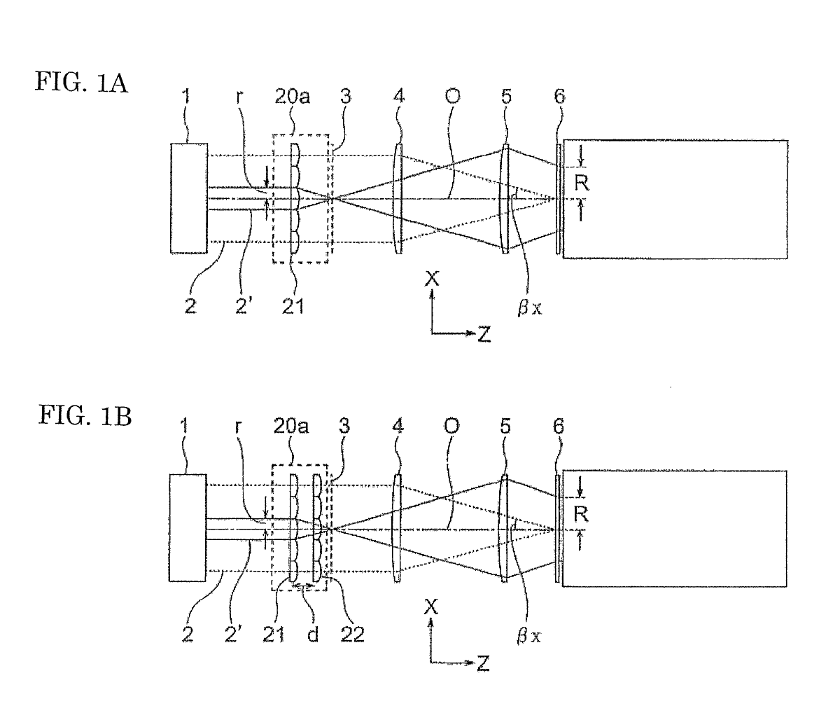

FIGS. 1A and 1B are explanatory views for explaining principles of variable beam size according to the invention. In each of FIGS. 1A and 1B, an optical system at which the invention is aimed is configured in such a manner that a long-axis-direction cylindrical array lens group 20a, a condenser lens 4, and a field lens 5 arranged in an ascending order of distance from a light source 1 are disposed between the light source 1 and an irradiated surface 6 irradiated with light emitted from the light source 1. FIG. 1A shows an example in which the number of lenses in the long-axis-direction cylindrical array lens group 20a is one. FIG. 1B shows an example in which the number of the lenses in the long-axis-direction cylindrical array lens group 20a is two.

In the example of FIG. 1B, a long-axis-direction beam size on the irradiated surface 6 can be changed when a lens interval d of the long-axis-direction cylindrical array lens group 20a is changed. The irradiated surface 6 and a projection surface 9 which will be described later have a conjugate relation with each other.

First, refer to FIG. 1A where the number of lenses in the long-axis-direction cylindrical array lens group 20a is one. In this case, assume that a focal length of a long-axis-direction cylindrical array lens 21 is f₁, a focal length of the condenser lens 4 is f₃, and a radius of the long-axis-direction cylindrical array lens is r. Then, abeam size R on the irradiated surface 6 can be expressed as follows:

R=(f₃/f₁)·r (1)

From the expression (1), it can be known that any one of the focal length f₁ of the first long-axis-direction cylindrical array lens 21, the focal length f₃ of the condenser lens 4, and the radius r of the first long-axis-direction cylindrical array lens 21 may be changed in order to change the beam size R on the irradiated surface 6. Accordingly, it is necessary to prepare cylindrical array lenses 21 and condenser lenses 4 having various focal lengths in order to make the beam size variable in this configuration.

Next, refer to FIG. 1B where the number of lenses in the long-axis-direction cylindrical array lens group 20a is two. In this case, assume that focal lengths of first and second long-axis-direction cylindrical array lenses 21 and 22 are f₁ and f₂, a lens interval between the first and second long-axis-direction cylindrical array lenses 21 and 22 is d, the focal length of the condenser lens 4 is f₃, and the radius of the long-axis-direction cylindrical array lens 21 is r. Then, a beam size R on the irradiated surface 6 can be expressed as follows:

R=f₃(f₁+f₂−d)r/(f₁·f₂) (2)

From the expression (2), it can be known that the lens interval d between the first and second long-axis-direction cylindrical array lenses 21 and 22 may be changed to change the beam size R on the irradiated surface 6 because the focal lengths f₁, f₂ and f₃ and the radius r of the long-axis-direction cylindrical array lens 21 are constants in the same optical system.

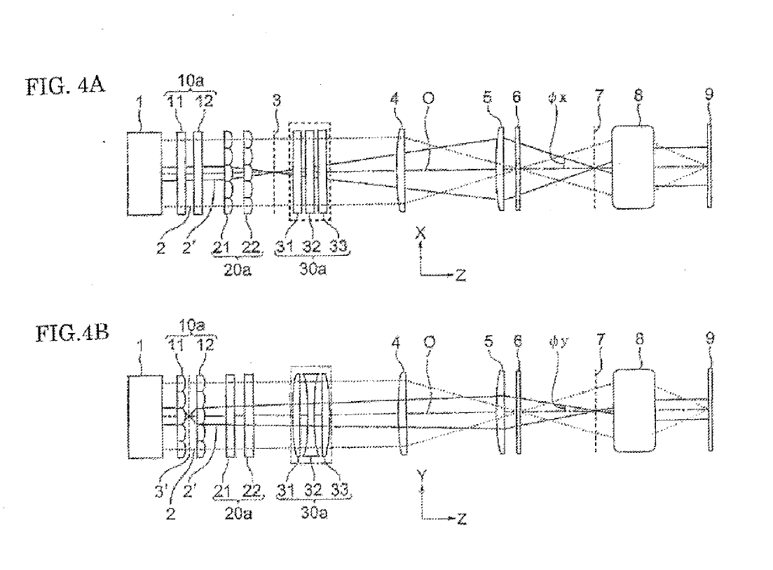

When the long-axis-direction cylindrical array lens group 20a in FIGS. 1A and 1B is replaced with a short-axis-direction cylindrical array lens group 10a having its axis located orthogonally to the long axis (see FIGS. 4A and 4B), the short-axis-direction cylindrical array lens group 10a can also change a short-axis-direction beam size with the same principles.

In an adjustable beam size illumination optical system using three short-axis-direction cylindrical telescope lenses, as shown in FIGS. 4A and 4B, the relation between the magnification of the three short-axis-direction cylindrical telescope lenses 31, 32 and 33 and a beam size on a mask surface can be derived as an approximation. By use of this approximation, it is easy to grasp the relation between the magnification and the beam size on the mask surface.

In FIGS. 1A and 1B, the reference symbol O designates an axis and the reference symbol βx designates an aperture angle.

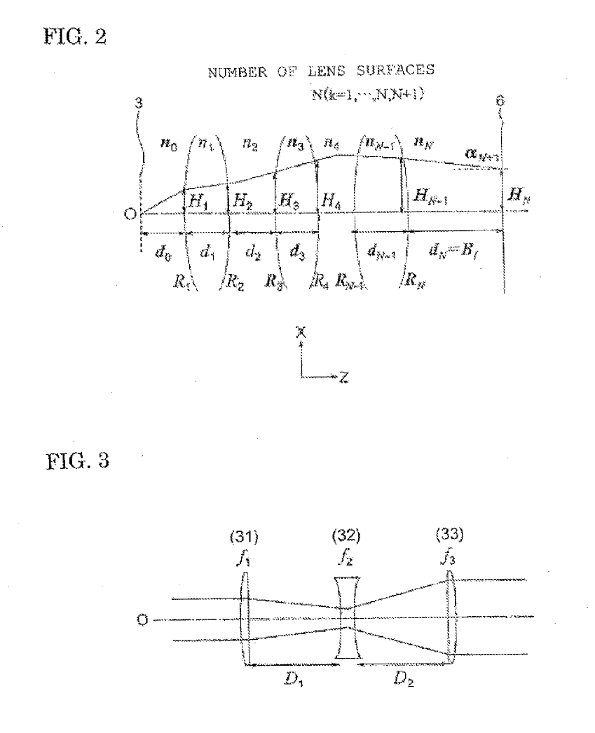

FIG. 2 is an explanatory view showing marginal rays (XZ section) from secondary light source images to the mask surface. FIG. 2 shows a state where short-axis-direction cylindrical telescope lenses with N lens surfaces are provided between secondary light source images 3 and the irradiated surface 6.

Assume that a refractive index posterior to the last lens surface is n_{N}, the beam size on the mask surface is H_{N}, and an angle between the marginal rays and the optical axis on the mask surface is α_{N+1}. Then, a posterior focal length B_{f} of the adjustable beam size illumination optical system whose lateral magnification β is 1 can be expressed as follows:

B_{f}=n_{N}·H_{N}/α_{N+1} (3)

Assume that a refractive index posterior to the last lens surface is n_{N}′, the beam size on the mask surface is H_{N}′, and an angle between the marginal rays and the optical axis on the mask surface is α_{N+1}′. Then, a posterior focal length B_{f}′ of the adjustable beam size illumination optical system whose lateral magnification β is arbitrary can be expressed as follows:

B_{f}′=n_{N}′·H_{N}′/α_{N+1}′ (4)

When a beam size on the first lens is H₁, a focal length fₐₗₗ of the adjustable beam size illumination optical system whose lateral magnification 0 is 1 can be expressed as follows:

fₐₗₗ=n_{N·H}₁/α_{N+1} (5)

When a beam size on the first lens is H₁′, a focal length fₐₗₗ′ of the adjustable beam size illumination optical system whose lateral magnification β is arbitrary can be expressed as follows:

fₐₗₗ′=n_{N}′·H₁′/α_{N+1}′ (6)

Further, from the expression (3) and the expression (5), the relational expression of the adjustable beam size illumination optical system whose lateral magnification β is 1 can be expressed as follows:

H₁=fₐₗₗ·H_{N}/B_{f} (7)

Similarly, from the expression (4) and the expression (6), the relational expression of the adjustable beam size illumination optical system whose lateral magnification β is arbitrary can be expressed as follows:

H₁′=fₐₗₗ′·H_{N}′/B_{f}′ (8)

From the expression (7) and the expression (8) where the lateral magnification is 1 and arbitrary respectively, the following expression can be derived:

B_{f}/fₐₗₗ=B_{f}·H_{N}′/fₐₗₗ·H_{N} (9)

and the lateral magnification ratio β and an angular magnification γ of the adjustable beam size illumination optical system have the following relation:

γ=1/β=H_{N}′/H_{N} (10)

Therefore, from the expression (8), the expression (9) and the expression (10), a principle expression of the adjustable beam size illumination optical system can be expressed as follows:

$$\begin{matrix}{H}_{N}^{′} = {B}_{f} \cdot {H}_{1}^{′} / {f}_{all} \cdot β \\ = {B}_{f} \cdot γ \cdot {H}_{1}^{′} / {f}_{all}\end{matrix} \qquad ( 11 )$$

From the expression (11), it can be known that the beam size H_{N}′ on the mask surface changes in accordance with the lateral magnification β or the angular magnification γ.

FIG. 3 is a view showing the three short-axis-direction cylindrical telescope lenses. In FIG. 3, when the magnification of the three cylindrical telescope lenses 31, 32 and 33 is β (from the lowest magnification β_{w} to the highest magnification βₜ), and a focal length of the second short-axis-direction cylindrical telescope lens 32 is f₂, focal lengths f₁ and f₃ of the first and third short-axis-direction cylindrical telescope lenses 31 and 33 can be obtained from the following expressions:

f₁=(1+1/β_{w})·f₂ (12)

f₃=(1+βₜ)·f₂ (13)

Further, when the focal lengths of the three short-axis-direction cylindrical telescope lenses 31, 32 and 33 are f₁, f₂ and f₃ and the lateral magnification is β, lens intervals D₁ and D₂ can be expressed by the following expressions respectively:

D₃=f₁−(f₃/β) (14)

D₂=f₃−β₁ (15)

In addition, the principle in which a long-axis-direction beam size on a mask surface changes when lens intervals of three long-axis-direction cylindrical telescope lenses change is the same.

Examples of the embodiment of the invention to which the aforementioned principles are applied will be described below with reference to the drawings.

### Example 1

Example 1 is an example in which aperture angles φx and φy in an adjustable beam size illumination optical system are changed to change the beam size.

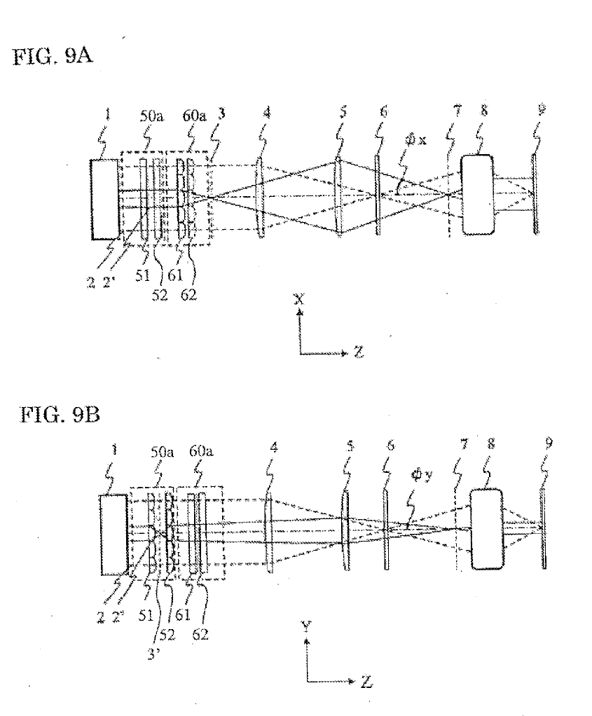

FIGS. 4A and 4B are explanatory views showing an adjustable beam size illumination optical system according to Example 1. FIG. 4A shows an XZ section of the beam size varying illumination optical system. FIG. 9B shows a YZ section of the adjustable beam size illumination optical system. In the following description, a suffix “′” attached to a lens system means that an interval between lenses has been changed.

In FIG. 9A, the adjustable beam size illumination optical system is constituted by an illumination optical system and a projection optical system. The illumination optical system includes a light source 1, two long-axis-direction cylindrical array lenses 21 and 22, and a condenser lens 4. The light source 1 such as an excimer laser or a mercury lamp forms parallel light. The two long-axis-direction cylindrical array lenses 21 and 22 form a plurality of secondary light source images 3 from the parallel light emitted from the light source 1. By the condenser lens 4, pieces of light from the secondary light source images 3 formed by the two long-axis-direction cylindrical array lenses 21 and 22 are condensed and superposed on an irradiated surface 6. Similarly, the projection optical system includes a field lens 5 and a projection lens 8. By the field lens 5, the secondary light source images 3 formed from the parallel light emitted from the light source 1 are reshaped on an entrance pupil plane 7 of the projection lens 8. The projection lens 8 forms an image of the irradiated surface 6 on a projection surface 9.

In FIG. 4B, similarly, the adjustable beam size illumination optical system includes an illumination optical system and a projection optical system. The illumination optical system includes a light source 1, two short-axis-direction cylindrical array lenses 11 and 12, three short-axis-direction cylindrical telescope lenses 31, 32 and 33, and a condenser lens 4. The light source 1 forms parallel light. The two short-axis-direction cylindrical array lenses 11 and 12 which are fixed form a plurality of secondary light source images 3′ from the parallel light emitted from the light source 1. A lens interval between adjacent ones of the three short-axis-direction cylindrical telescope lenses 31, 32 and 33 can be changed. By the condenser lens 4, pieces of light from the secondary light source images 3′ are condensed and superposed on an irradiated surface 6. Similarly, the projection optical system includes a field lens 5 and a projection lens 8. By the field lens 5, the secondary light source images 3′ formed from the parallel light from the light source 1 are reshaped on an entrance pupil plane 7 of the projection lens 8. The projection lens 8 forms an image of the irradiated surface 6 on a projection surface 9. As shown in FIGS. 1A and 1B and FIGS. 4A and 4B, the broken line 2 denotes chief rays while the solid line 2′ denotes marginal rays in the specification.

The two short-axis-direction cylindrical array lenses 11 and 12 form a short-axis-direction cylindrical array lens group 10a. The two long-axis-direction cylindrical array lenses 21 and 22 form a long-axis-direction cylindrical array lens group 20a. The three short-axis-direction cylindrical telescope lenses 31, 32 and 33 form a short-axis-direction cylindrical telescope lens group 30a. In FIGS. 4A and 4B, φx and φy designate an x-axis-direction aperture angle and a y-axis-direction aperture angle of the adjustable beam size illumination optical system respectively with reference to an axis O.

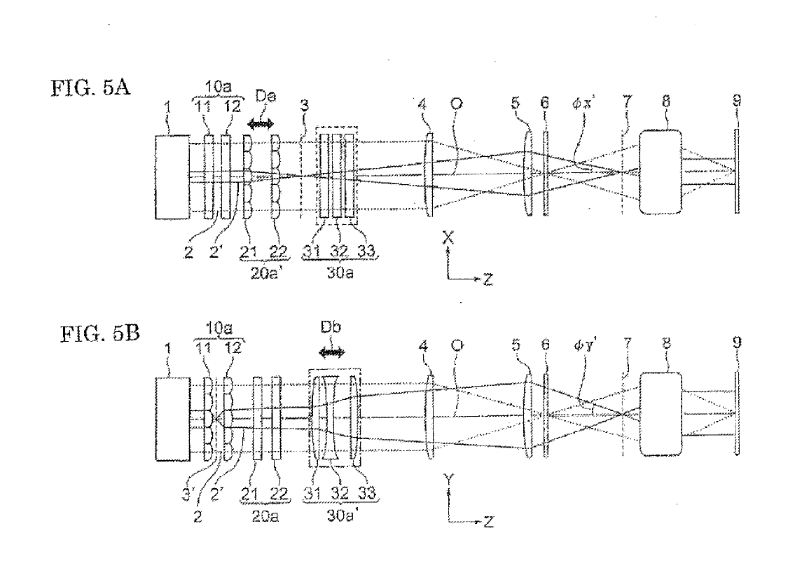

FIGS. 5A and 5B are views showing examples in which the aperture angles φx and φy are changed to change the beam size, respectively. FIG. 5A shows an example in which the aperture angle in the X-axis direction is changed. FIG. 5B shows an example in which the aperture angle in the Y-axis direction is changed. FIG. 5A corresponds to FIG. 4A while FIG. 58 corresponds to FIG. 4B.

FIG. 5A shows an example in which a lens interval Da of the group 20a′ of two long-axis-direction cylindrical array lenses in FIG. 4A is changed (expanded) to change (elongate) the focal length so that the aperture angle φx of illumination light with respect to the entrance pupil plane 7 of the projection lens 8 is changed to a small aperture angle φx′. In this manner, although the long-axis-direction beam size width on the projection surface 9 is reduced, the short-axis-direction beam size width on the projection surface 9 is unchanged because the focal length of the group 30a of three short-axis-direction cylindrical telescope lenses is unchanged.

FIG. 5B shows an example in which a lens interval Db of the group 30a′ of three short-axis-direction cylindrical telescope lenses in FIG. 48 is changed (expanded) to change (elongate) the focal length so that the aperture angle φy of illumination light with respect to the entrance pupil plane 7 of the projection lens 8 is changed to a small aperture angle φy′. In this manner, although the long-axis-direction beam size width on the projection surface 9 is decreased, the short-axis-direction beam size width on the projection surface 9 is unchanged because the focal length of the group 20a of two long-axis-direction cylindrical array lenses is unchanged. Places of the three lenses 31, 32 and 33 of the short-axis-direction cylindrical telescope lens group 30a′ which can be moved to change the focal length are set in accordance with D₁ and/or D₂ derived from the expression (14) and the expression (15).

### Example 2

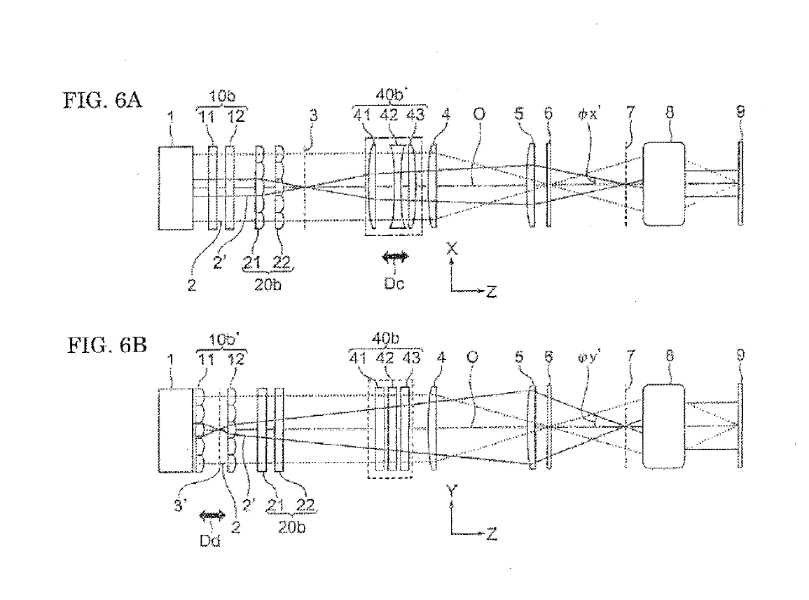

FIGS. 6A and 6B are explanatory views showing an adjustable beam size illumination optical system according to Example 2. FIG. 6A shows an XZ section of the adjustable beam size illumination optical system. FIG. 68 shows a YZ section of the adjustable beam size illumination optical system. In Example 2, the cylindrical telescope lens group 30a is rotated by 90° with respect to Example 1 so as to serve as a long-axis-direction cylindrical telescope lens group 40b, 40b′. The other constituent portions, which are equivalent to those in Example 1, are referred to by the same numerals and signs correspondingly, and redundant description thereof will be omitted.

In Example 2, the beam size is changed as follows. That is, when a lens interval Dc between adjacent ones of three long-axis-direction cylindrical telescope lenses 41, 42 and 43 of the long-axis-direction cylindrical telescope lens group 40b′ is changed for the beam size in the long axis (X) direction, and a lens interval Dd between lenses 11 and 12 of a short-axis-direction cylindrical array lens group 10b is changed for the beam size in the short axis (Y) direction. Thus, aperture angles φx and φy in the X and Y directions are changed respectively to change the beam size.

In Example 2, similarly to Example 1, focal lengths of the long-axis-direction cylindrical telescope lens group 40b′ and the short-axis-direction cylindrical array lens group 10b′ are changed by a known translation mechanism for use in such an optical apparatus, so that the beam size can be changed desirably in the X and Y directions individually.

The respective portions which are not described particularly have equivalent configurations and functions to those in Example 1.

### Example 3

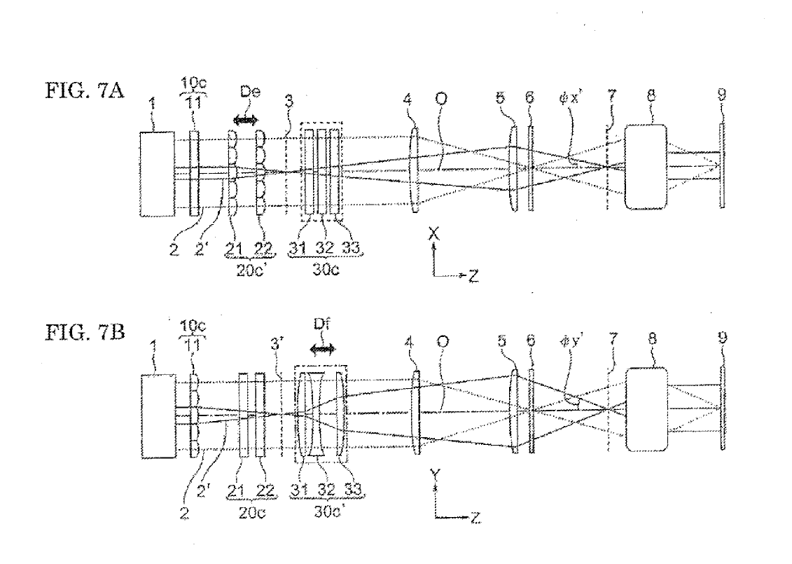

FIGS. 7A and 7B are explanatory views showing an adjustable beam size illumination optical system according to Example 3. FIG. 7A shows an XZ section of the adjustable beam size illumination optical system. FIG. 7B shows a YZ section of the adjustable beam size illumination optical system. In Example 3, the cylindrical array lens 12 is removed from the cylindrical array lens group 10b′ in Example 1 to leave only the cylindrical array lens 11 as a short-axis-direction cylindrical array lens (depicted as cylindrical array lens group 10c in FIGS. 7A and 7B). A lens interval De of a long-axis-direction cylindrical array lens group 20c′ is changed for the beam size in the long axis (X) direction and a lens interval Df of a short-axis-direction cylindrical telescope lens group 30c′ is changed for the beam size in the short axis (Y) direction. Thus, aperture angles φx and φy in the X and Y directions are changed to change the beam size.

In Example 3, similarly to Example 1, focal lengths of the short-axis-direction cylindrical telescope lens group 30c′ and the long-axis-direction cylindrical array lens group 20c′ are changed by a known translation mechanism for use in such an optical apparatus, so that the beam size can be changed desirably in the X and Y directions individually.

The respective portions which are not described particularly have equivalent configurations and functions to those in Example 1.

### Example 4

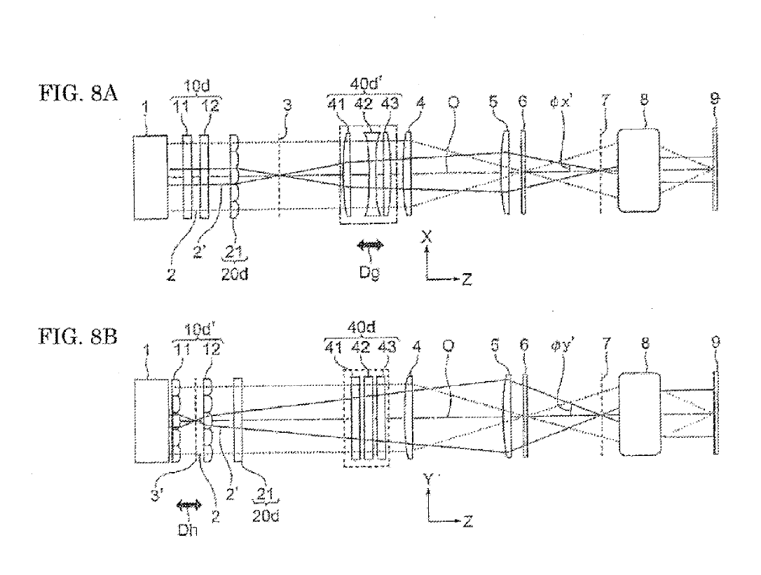

FIGS. 8A and 8B are explanatory views showing an adjustable beam size illumination optical system according to Example 4. FIG. 8A shows an XZ section of the adjustable beam size illumination optical system. FIG. 8B shows a YZ section of the adjustable beam size illumination optical system. In Example 4, the cylindrical array lens 22 is removed from the cylindrical array lens group 20a in Example 1 to leave only the cylindrical array lens 21 as a short-axis-direction cylindrical array lens (depicted as cylindrical array lens group 10d in FIGS. 8A and 8B). A lens interval Dg of a long-axis-direction cylindrical telescope lens group 40d′ is changed for the beam size in the long axis (X) direction and a lens interval Dh of the short-axis-direction cylindrical array lens group 10d′ is changed for the beam size in the short axis (Y) direction. Thus, aperture angles φx and φy in the X and Y directions are changed to change the beam size.

In Example 4, similarly to Example 1, focal lengths of the long-axis-direction cylindrical telescope lens group 40d′ and the short-axis-direction cylindrical array lens group 10d′ are changed by a known translation mechanism for use in such an optical apparatus, so that the beam size can be changed desirably in the X and Y directions individually.

The respective portions which are not described particularly have equivalent configurations and functions to those in Example 1.

### Example 5

Example 5 shows an example in which aperture angles φx and φy in an adjustable beam size illumination optical system are changed to change the beam size.

FIGS. 9A and 9B are explanatory views showing an adjustable beam size illumination optical system according to Example 5. FIG. 9A shows an XZ section of the adjustable beam size illumination optical system. FIG. 9B shows a YZ section of the adjustable beam size illumination optical system. In the following description, a suffix “′” attached to a lens system means that an interval between lenses has been changed.

In FIG. 9A, the adjustable beam size illumination optical system is constituted by an illumination optical system and a projection optical system. The illumination optical system includes a light source 1, two long-axis-direction cylindrical array lenses 61 and 62, two short-axis-direction cylindrical array lenses 51 and 52, and a condenser lens 4. The light source 1 such as an excimer laser or a mercury lamp forms parallel light. The two long-axis-direction cylindrical array lenses 61 and 62 whose lens interval can be changed form a plurality of secondary light source images 3 from the parallel light emitted from the light source 1. The lens interval between the short-axis-direction cylindrical array lenses 51 and 52 can be changed likewise. By the condenser lens 4, pieces of light from the secondary light source images 3 are condensed and superposed on an irradiated surface 6. Similarly, the projection optical system includes a field lens 5 and a projection lens 8. By the field lens 5, the secondary light source images 3 formed from the parallel light emitted from the light source 1 are reshaped on an entrance pupil plane 7 of the projection lens 8. The projection lens 8 forms an image of the irradiated surface 6 on a projection surface 9.

In FIG. 9B, similarly, the adjustable beam size illumination optical system includes an illumination optical system and a projection optical system. The illumination optical system includes a light source 1, two short-axis-direction cylindrical array lenses 51 and 52, two long-axis-direction cylindrical array lenses 61 and 62, and a condenser lens 4. The light source 1 forms parallel light. The two short-axis-direction cylindrical array lenses 51 and 52 whose lens interval can be changed form a plurality of secondary light source images 3′ from the parallel light emitted from the light source 1. The lens interval between the long-axis-direction cylindrical array lenses 61 and 62 can be changed likewise. By the condenser lens 4, pieces of light from the secondary light source images 3′ are condensed and superposed on an irradiated surface 6. Similarly, the projection optical system includes a field lens 5 and a projection lens 8. By the field lens 5, the secondary light source images 3′ formed from the parallel light from the light source 1 are reshaped on an entrance pupil plane 7 of the projection lens 8. The projection lens 8 forms an image of the irradiated surface 6 on a projection surface 9. As shown in FIGS. 9A and 9B, the broken line 2 denotes chief rays while the solid line 2′ denotes marginal rays.

The two short-axis-direction cylindrical array lenses 51 and 52 form a short-axis-direction cylindrical array lens group 50a. The two long-axis-direction cylindrical array lenses 61 and 62 form a long-axis-direction cylindrical array lens group 60a.

In FIGS. 9A and 9B, φx and φy designate an x-axis-direction aperture angle and a y-axis-direction aperture angle of the adjustable beam size illumination optical system respectively with reference to an axis O.

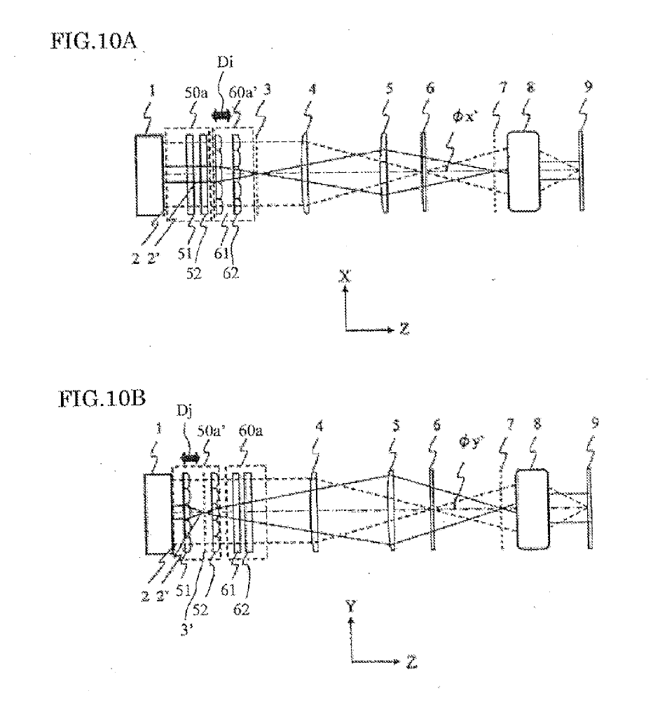

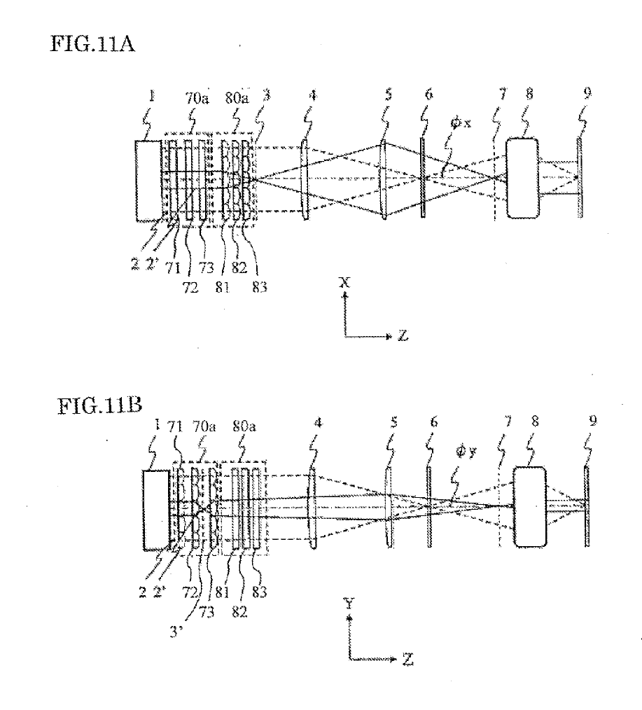

FIGS. 10A and 10B are views showing examples in which the aperture angles φx and φy are changed to change the beam size, respectively. FIG. 10A shows an example in which the aperture angle in the X-axis direction is changed. FIG. 10B shows an example in which the aperture angle in the Y-axis direction is changed. FIG. 10A corresponds to FIG. 9A while FIG. 10B corresponds to FIG. 9B.

FIG. 10A shows an example in which a lens interval Di of the group 60a′ of two long-axis-direction cylindrical array lenses in FIG. 9A is changed (expanded) to change (elongate) the focal length so that the aperture angle φx of illumination light with respect to the entrance pupil plane 7 of the projection lens 8 is changed to a small aperture angle φx′. In this manner, the long-axis-direction beam size width on the projection surface 9 is reduced. On this occasion, the short-axis-direction beam size width is unchanged.

FIG. 10B shows an example in which a lens interval Dj of the group 50a′ of two short-axis-direction cylindrical array lenses in FIG. 9B is changed (expanded) to change (elongate) the focal length so that the aperture angle φy of illumination light with respect to the entrance pupil plane 7 of the projection lens 8 is changed to a large aperture angle φy′. In this manner, the short-axis-direction beam size width on the projection surface 9 is increased.

Although a mechanism for changing an interval between lenses is not shown particularly here, a known translation mechanism for use in such an optical apparatus can be used satisfactorily. In any case, the focal lengths of the long-axis-direction cylindrical array lens group 60a′ and the short-axis-direction cylindrical array lens group 50a′ are changed so that the beam size can be changed desirably in the X and Y directions individually. The beam size can be changed in the X and Y directions successively or can be changed in both the X and Y directions concurrently.

### Example 6

FIGS. 11A and 11B are explanatory views showing an adjustable beam size illumination optical system according to Example 6. FIG. 11A shows an XZ section of the adjustable beam size illumination optical system. FIG. 11B shows a YZ section of the adjustable beam size illumination optical system. In Example 6, the number of cylindrical array lenses in each of the short-axis-direction cylindrical array lens group 50a and the long-axis-direction cylindrical array lens group 60a in Example 5 is increased from two to three (depicted as cylindrical array lens group 70a, 80a in FIGS. 11A and 11B). The other constituent portions, which are equivalent to those in Example 1, are referred to by the same numerals and signs correspondingly, and redundant description thereof will be omitted.

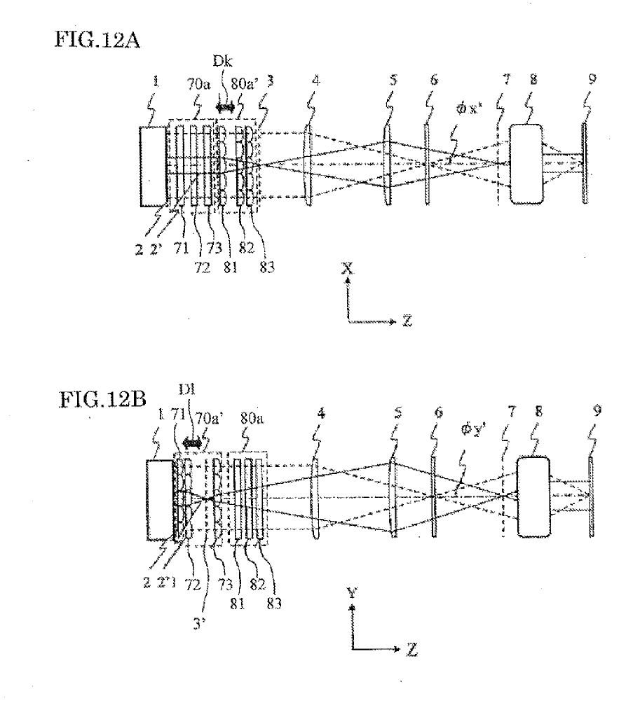

In Example 6, the beam size is changed as follows. That is, when a lens interval Dk between adjacent ones of three cylindrical array lenses 81, 82 and 83 of the long-axis-direction cylindrical array lens group 80a′ is changed for the beam size in the long axis (X) direction as shown in FIG. 12A, and a lens interval Dl between adjacent ones of three cylindrical array lenses 71, 72 and 73 of the short-axis-direction cylindrical array lens group 70a′ is changed for the beam size in the short axis (Y) direction as shown in FIG. 12B. Thus, aperture angles φx′ and φy′ in the X and Y directions are changed respectively to change the beam size.

In Example 6, similarly to Example 5, focal lengths of the long-axis-direction cylindrical array lens group 80a′ and the short-axis-direction cylindrical array lens group 70a′ are changed by a known translation mechanism for use in such an optical apparatus, so that the beam size can be changed desirably in the X and Y directions individually.

The respective portions which are not described particularly have equivalent configurations and functions to those in Example 5.

### Example 7

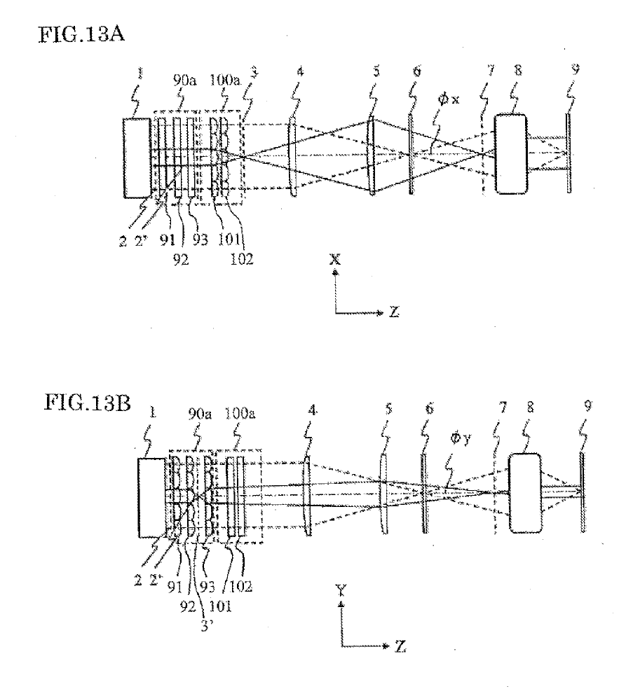

FIGS. 13A and 13B are explanatory views showing an adjustable beam size illumination optical system according to Example 7. FIG. 13A shows an XZ section of the adjustable beam size illumination optical system. FIG. 13B shows a YZ section of the adjustable beam size illumination optical system. In Example 7, the number of cylindrical array lenses in the short-axis-direction cylindrical array lens group 50a in Example 5 is increased from two to three (depicted as cylindrical array lens group 90a, 100a in FIGS. 13A and 13B). The other constituent portions, which are equivalent to those in Example 5, are referred to by the same numerals and signs correspondingly, and redundant description thereof will be omitted.

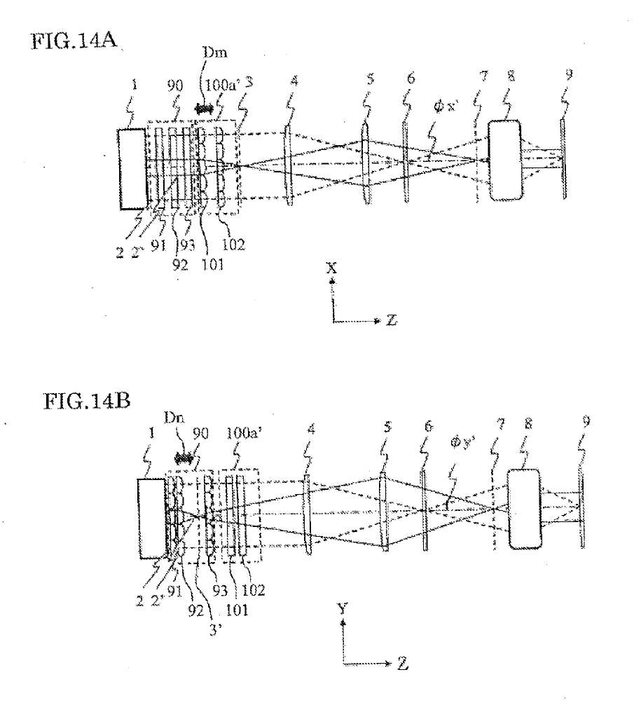

In Example 7, the beam size is changed as follows. That is, when a lens interval Dm between two cylindrical array lenses 101 and 102 of a long-axis-direction cylindrical array lens group 100a′ is changed for the beam size in the long axis (X) direction as shown in FIG. 14A, and a lens interval Dn between adjacent ones of three cylindrical array lenses 91, 92 and 93 of the short-axis-direction cylindrical array lens group 90a′ is changed for the beam size in the short axis (Y) direction as shown in FIG. 14B. Thus, aperture angles φx and φy in the X and Y directions are changed respectively to change the beam size.

In Example 7, similarly to Example 5, focal lengths of the long-axis-direction cylindrical array lens group 100a′ and the short-axis-direction cylindrical array lens group 90a′ are changed by a known translation mechanism for use in such an optical apparatus, so that the beam size can be changed desirably in the X and Y directions individually.

The respective portions which are not described particularly have equivalent configurations and functions to those in Example 5.

### Example 8

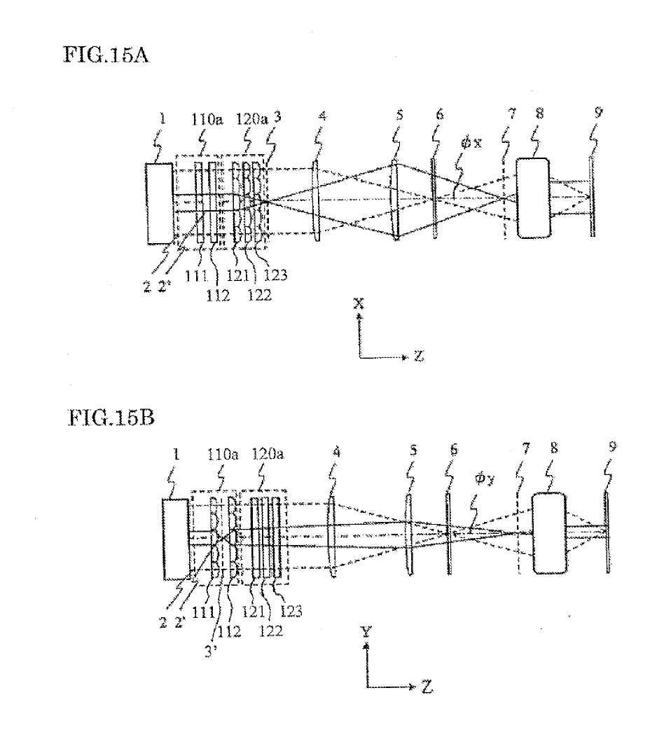

FIGS. 15A and 15B are explanatory views showing an adjustable beam size illumination optical system according to Example 8. FIG. 15A shows an XZ section of the adjustable beam size illumination optical system. FIG. 15B shows a YZ section of the adjustable beam size illumination optical system. In Example 8, the number of cylindrical array lenses in the long-axis-direction cylindrical array lens group 60a in Example 5 is increased from two to three (depicted as cylindrical array lens group 110a, 120a in FIGS. 15A and 15B). The other constituent portions, which are equivalent to those in Example 5, are referred to by the same numerals and signs correspondingly, and redundant description thereof will be omitted.

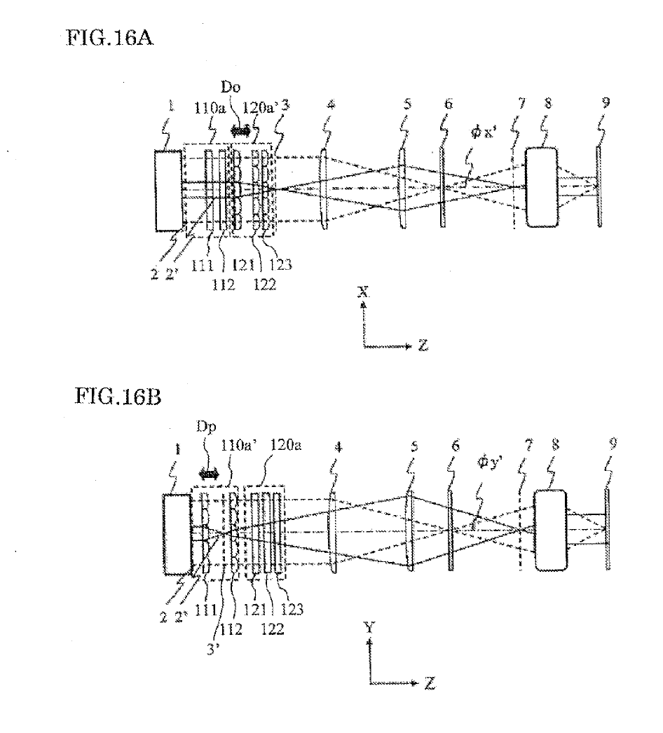

In Example 8, the beam size is changed as follows. That is, when a lens interval Do between adjacent ones of three cylindrical array lenses 121, 122 and 123 of the long-axis-direction cylindrical array lens group 120a′ is changed for the beam size in the long axis (X) direction as shown in FIG. 16A, and a lens interval Op between two cylindrical array lenses 111 and 112 of a short-axis-direction cylindrical array lens group 110a′ is changed for the beam size in the short axis (Y) direction as shown in FIG. 16B. Thus, aperture angles φx and φy in the X and Y directions are changed respectively to change the beam size.

In Example 8, similarly to Example 5, focal lengths of the long-axis-direction cylindrical array lens group 120a′ and the short-axis-direction cylindrical array lens group 110a′ are changed by a known translation mechanism for use in such an optical apparatus, so that the beam size can be changed desirably in the X and Y directions individually.

The respective portions which are not described particularly have equivalent configurations and functions to those in Example 5.

### Example 9

Example 9 shows an example in which aperture angles φx and φy in an adjustable beam size illumination optical system are changed to change the beam size.

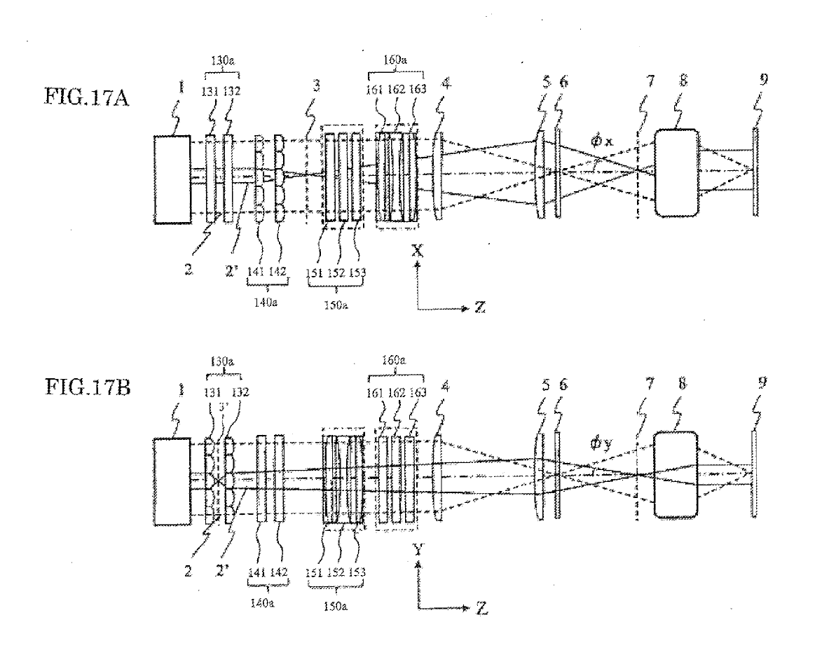

FIGS. 17A and 17B are explanatory views showing an adjustable beam size illumination optical system according to Example 9. FIG. 17A shows an XZ section of the adjustable beam size illumination optical system. FIG. 17B shows a YZ section of the adjustable beam size illumination optical system. In the following description, a suffix “′” attached to a lens system means that an interval between lenses has been changed.

In FIG. 17A, the adjustable beam size illumination optical system is constituted by an illumination optical system and a projection optical system. The illumination optical system includes a light source 1, two long-axis-direction cylindrical array lenses 141 and 142, three long-axis-direction cylindrical telescope lenses 161, 162 and 163, and a condenser lens 4. The light source 1 such as an excimer laser or a mercury lamp forms parallel light. The two long-axis-direction cylindrical array lenses 141 and 142 which are fixed form a plurality of secondary light source images 3 from the parallel light emitted from the light source 1. A lens interval between adjacent ones of the three long-axis-direction cylindrical telescope lenses 161, 162 and 163 can be changed. By the condenser lens 4, pieces of light from the secondary light source images 3 formed by the two long-axis-direction cylindrical array lenses 141 and 192 which are fixed are condensed and superposed on an irradiated surface 6. Similarly, the projection optical system includes a field lens 5 and a projection lens 8. By the field lens 5, the secondary light source images 3 formed from the parallel light emitted from the light source 1 are reshaped on an entrance pupil plane 7 of the projection lens 8. The projection lens 8 forms an image of the irradiated surface 6 on a projection surface 9.

Also in FIG. 17B, the adjustable beam size illumination optical system includes an illumination optical system and a projection optical system. The illumination optical system includes a light source 1, two short-axis-direction cylindrical array lenses 131 and 132, three short-axis-direction cylindrical telescope lenses 151, 152 and 153, and a condenser lens 4. The light source 1 forms parallel light. The two short-axis-direction cylindrical array lenses 131 and 132 which are fixed form a plurality of secondary light source images 3′ from the parallel light emitted from the light source 1. A lens interval between adjacent ones of the three short-axis-direction cylindrical telescope lenses 151, 152 and 153 can be changed. By the condenser lens 4, pieces of light from the secondary light source images 3′ formed by the two short-axis-direction cylindrical array lenses 131 and 132 which are fixed are condensed and superposed on an irradiated surface 6. Similarly, the projection optical system includes a field lens 5 and a projection lens 8. By the field lens 5, the secondary light source images 3′ formed from the parallel light from the light source 1 are reshaped on an entrance pupil plane 7 of the projection lens 8. The projection lens 8 forms an image of the irradiated surface 6 on a projection surface 9. In FIGS. 17A and 17B, the broken line 2 denotes chief rays while the solid line 2′ denotes marginal rays.

The two short-axis-direction cylindrical array lenses 131 and 132 form a short-axis-direction cylindrical array lens group 130a. The two long-axis-direction cylindrical array lenses 141 and 142 form a long-axis-direction cylindrical array lens group 140a. The three short-axis-direction cylindrical telescope lenses 151, 152 and 153 form a short-axis-direction cylindrical telescope lens group 150a. The three long-axis-direction cylindrical telescope lenses 161, 162 and 163 form a long-axis-direction cylindrical telescope lens group 160a. In FIGS. 17A and 17B, φx and φy designate an X-axis-direction aperture angle and a Y-axis-direction aperture angle of the adjustable beam size illumination optical system respectively with reference to an axis O.

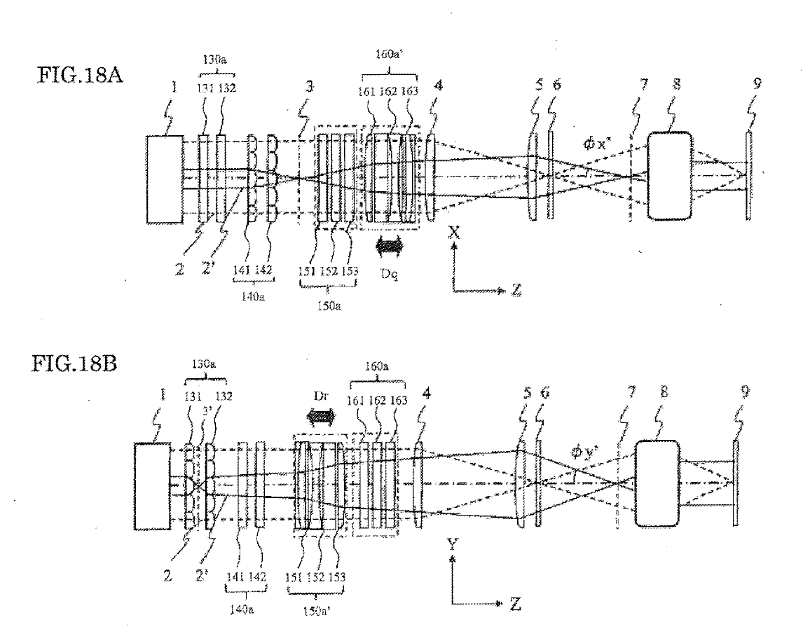

FIGS. 18A and 18B are views showing examples in which the aperture angles φx and φy are changed to change the beam size, respectively. FIG. 18A shows an example in which the aperture angle in the X-axis direction is changed. FIG. 18B shows an example in which the aperture angle in the Y-axis direction is changed. FIG. 18A corresponds to FIG. 17A while FIG. 18B corresponds to FIG. 17B.

FIG. 18A shows an example in which a lens interval Dq of the group of three long-axis-direction cylindrical telescope lenses in FIG. 17A is changed (expanded) to change (elongate) the focal length so that the aperture angle φx of illumination light with respect to the entrance pupil plane 7 of the projection lens 8 is changed to a small aperture angle φx′. In this manner, although the long-axis-direction beam size width on the projection surface 9 is reduced, the short-axis-direction beam size width on the projection surface 9 is unchanged because the focal length of the group 150a of three short-axis-direction cylindrical telescope lenses is unchanged.

FIG. 18B shows an example in which a lens interval Dr of the group of three short-axis-direction cylindrical telescope lenses in FIG. 17A is changed (expanded) to change (elongate) the focal length so that the aperture angle φy of illumination light with respect to the entrance pupil plane 7 of the projection lens 8 is changed to a large aperture angle φy′. In this manner, although the short-axis-direction beam size width on the projection surface 9 is increased, the long-axis-direction beam size width on the projection surface 9 is unchanged because the focal length of the group 160a of three long-axis-direction cylindrical telescope lenses is unchanged. Places of the three lenses 151, 152 and 153 of the short-axis-direction cylindrical telescope lens group 150a′ and the three lenses 161, 162 and 163 of the long-axis-direction cylindrical telescope lens group 160a′ which can be moved to change the focal lengths are set in accordance with one of D₁ and D₂ derived from the expression (14) and the expression (15).

Although a mechanism for changing an interval between lenses is not shown particularly here, a known translation mechanism for use in such an optical apparatus can be used satisfactorily. In any case, the focal lengths of the long-axis-direction cylindrical telescope lens group 160a′ and the short-axis-direction cylindrical telescope lens group 150a′ are changed so that the beam size can be changed desirably in the X and Y directions individually. The beam size can be changed in the X and Y directions successively or can be changed in both the X and Y directions concurrently.

### Example 10

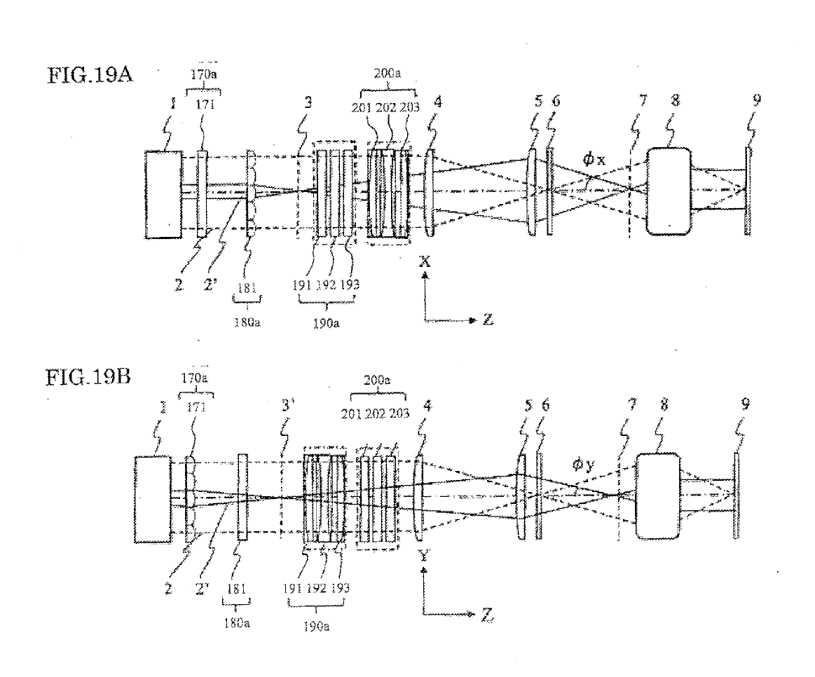

FIGS. 19A and 19B are explanatory views showing an adjustable beam size illumination optical system according to Example 10. FIG. 19A shows an XZ section of the adjustable beam size illumination optical system. FIG. 19B shows a YZ section of the adjustable beam size illumination optical system. In Example 10, the number of cylindrical array lenses in each of the short-axis-direction cylindrical array lens group 130a and the long-axis-direction cylindrical array lens group 140a in Example 9 is reduced from two to one (depicted as cylindrical array lens group 170a, 180a in FIGS. 19A and 19B). The other constituent portions, which are equivalent to those in Example 9, are referred to by the same numerals and signs correspondingly, and redundant description thereof will be omitted.

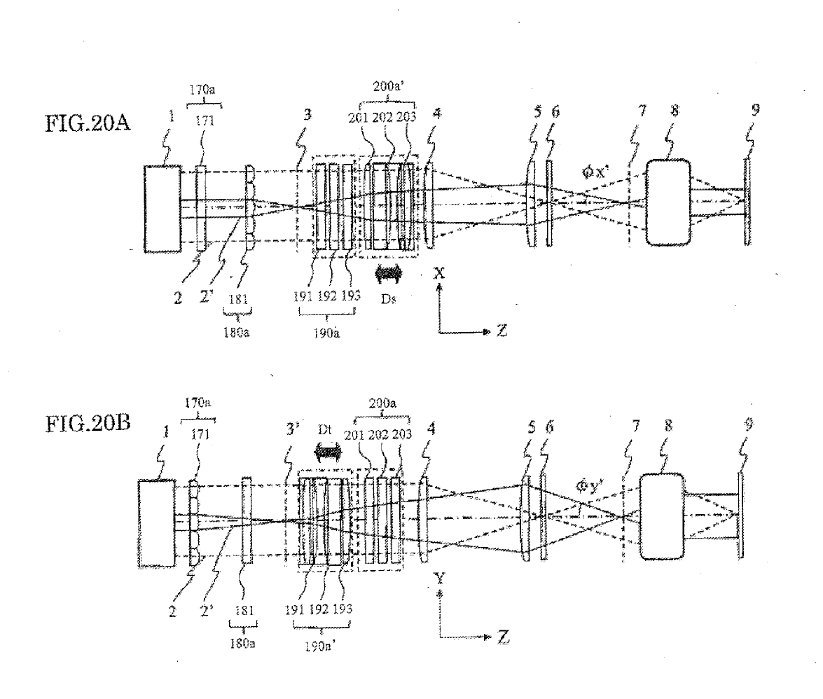

Also in Example 10, the beam size is changed as follows. That is, when a lens interval Ds between adjacent ones of three cylindrical telescope lenses 201, 202 and 203 of a long-axis-direction cylindrical telescope lens group 200a′ is changed for the beam size in the long axis (X) direction as shown in FIG. 20A, and a lens interval Dt between adjacent ones of three cylindrical telescope lenses 191, 192 and 193 of a short-axis-direction cylindrical telescope lens group 190a′ is changed for the beam size in the short axis (Y) direction as shown in FIG. 20B. Thus, aperture angles φx and φy in the X and Y directions are changed respectively to change the beam size.

In Example 10, similarly to Example 9, focal lengths of the long-axis-direction cylindrical telescope lens group 200a′ and the short-axis-direction cylindrical telescope lens group 190a′ are changed by a known translation mechanism for use in such an optical apparatus, so that the beam size can be changed desirably in the X and Y directions individually.

The respective portions which are not described particularly have equivalent configurations and functions to those in Example 9.

### Example 11

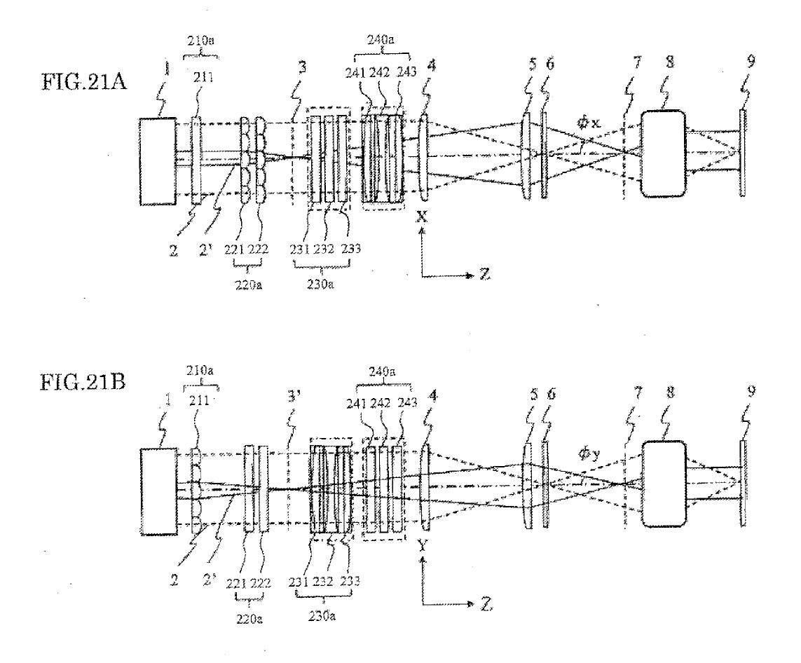

FIGS. 21A and 21B are explanatory views showing an adjustable beam size illumination optical system according to Example 11. FIG. 21A shows an XZ section of the adjustable beam size illumination optical system. FIG. 21B shows a YZ section of the adjustable beam size illumination optical system. In Example 11, the number of cylindrical array lenses in the short-axis-direction cylindrical array lens group 130a in Example 9 is reduced from two to one (depicted as cylindrical array lens group 210a). The other constituent portions, which are equivalent to those in Example 9, are referred to by the same numerals and signs correspondingly, and redundant description thereof will be omitted.

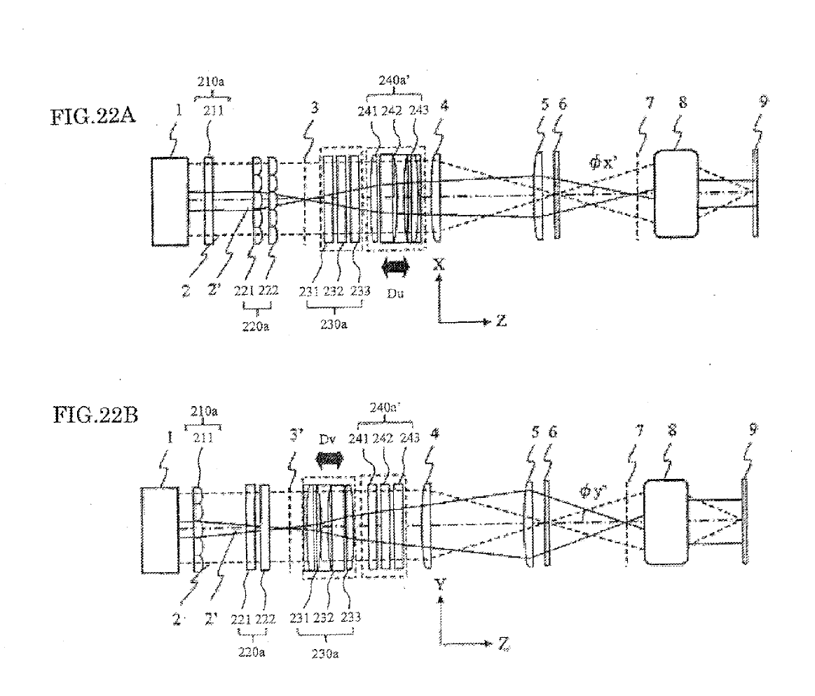

Also in Example 11, the beam size is changed as follows. That is, when a lens interval Du between adjacent ones of three cylindrical telescope lenses 241, 242 and 243 of a long-axis-direction cylindrical telescope lens group 240a′ is changed for the beam size in the long axis (X) direction as shown in FIG. 22A, and a lens interval Dv between adjacent ones of three cylindrical telescope lenses 231, 232 and 233 of a short-axis-direction cylindrical telescope lens group 230a′ is changed for the beam size in the short axis (Y) direction as shown in FIG. 22B. Thus, aperture angles φx and φy in the X and Y directions are changed respectively to change the beam size.

In Example 11, similarly to Example 9, focal lengths of the long-axis-direction cylindrical telescope lens group 240a′ and the short-axis-direction cylindrical telescope lens group 230a′ are changed by a known translation mechanism for use in such an optical apparatus, so that the beam size can be changed desirably in the X and Y directions individually.

The respective portions which are not described particularly have equivalent configurations and functions to those in Example 9.

### Example 12

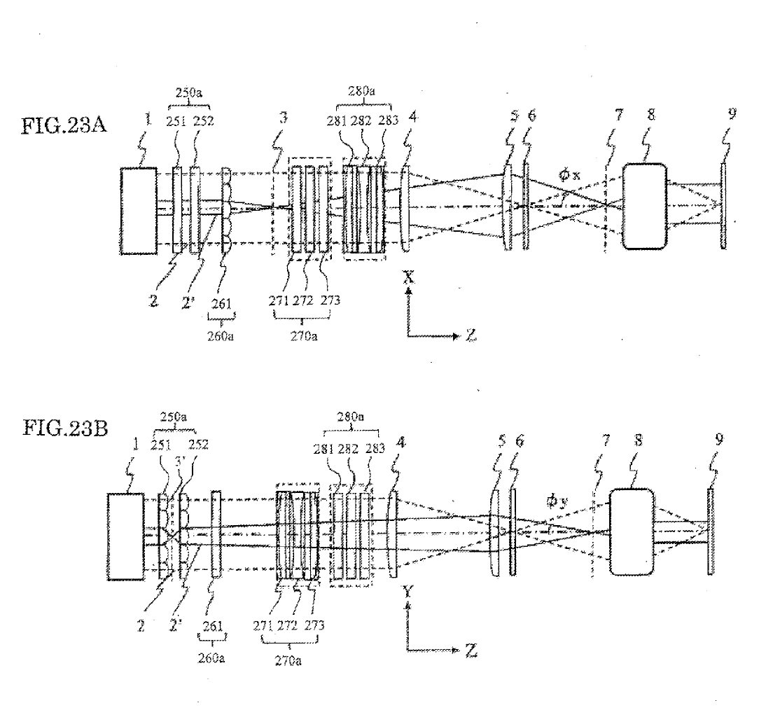

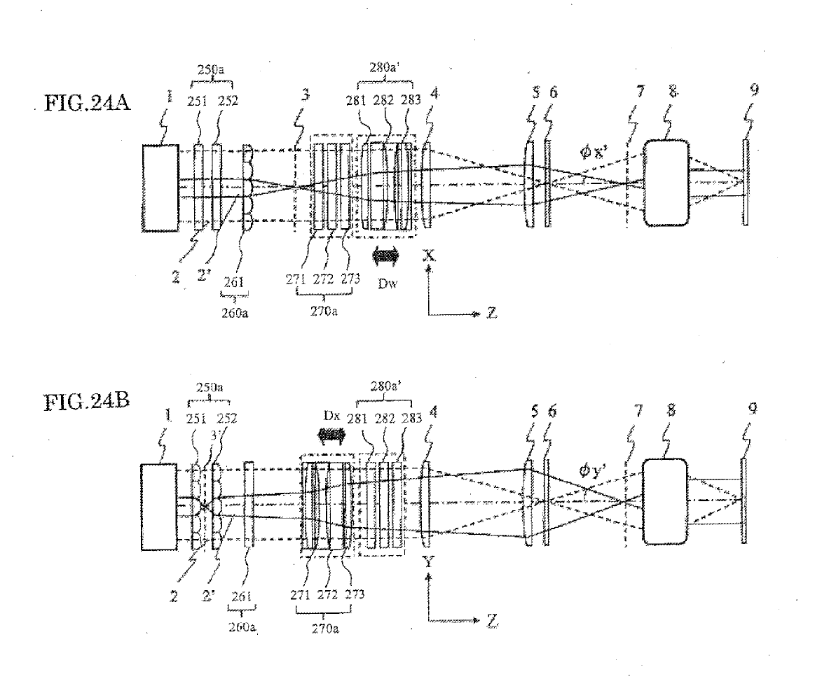

FIGS. 23A and 23B are explanatory views showing an adjustable beam size illumination optical system according to Example 12. FIG. 23A shows an XZ section of the adjustable beam size illumination optical system. FIG. 23B shows a YZ section of the adjustable beam size illumination optical system. In Example 12, the number of cylindrical array lenses in the long-axis-direction cylindrical array lens group 140a in Example 9 is reduced from two to one (depicted as cylindrical array lens group 260a). The other constituent portions are equivalent to those in Example 9, so that redundant description thereof will be omitted.

Also in Example 12, the beam size is changed as follows. That is, when a lens interval Dw between adjacent ones of three cylindrical telescope lenses 281, 282 and 283 of a long-axis-direction cylindrical telescope lens group 280a′ is changed for the beam size in the long axis (X) direction as shown in FIG. 24A, and a lens interval Dx between adjacent ones of three cylindrical telescope lenses 271, 272 and 273 of a short-axis-direction cylindrical telescope lens group 270a′ is changed for the beam size in the short axis (Y) direction as shown in FIG. 24B. Thus, aperture angles φx and φy in the X and Y directions are changed respectively to change the beam size.

In Example 12, similarly to Example 9, focal lengths of the long-axis-direction cylindrical telescope lens group 280a′ and the short-axis-direction cylindrical telescope lens group 270a′ are changed by a known translation mechanism for use in such an optical apparatus, so that the beam size can be changed desirably in the X and Y directions.

The respective portions which are not described particularly have equivalent configurations and functions to those in Example 9.

### Example 13

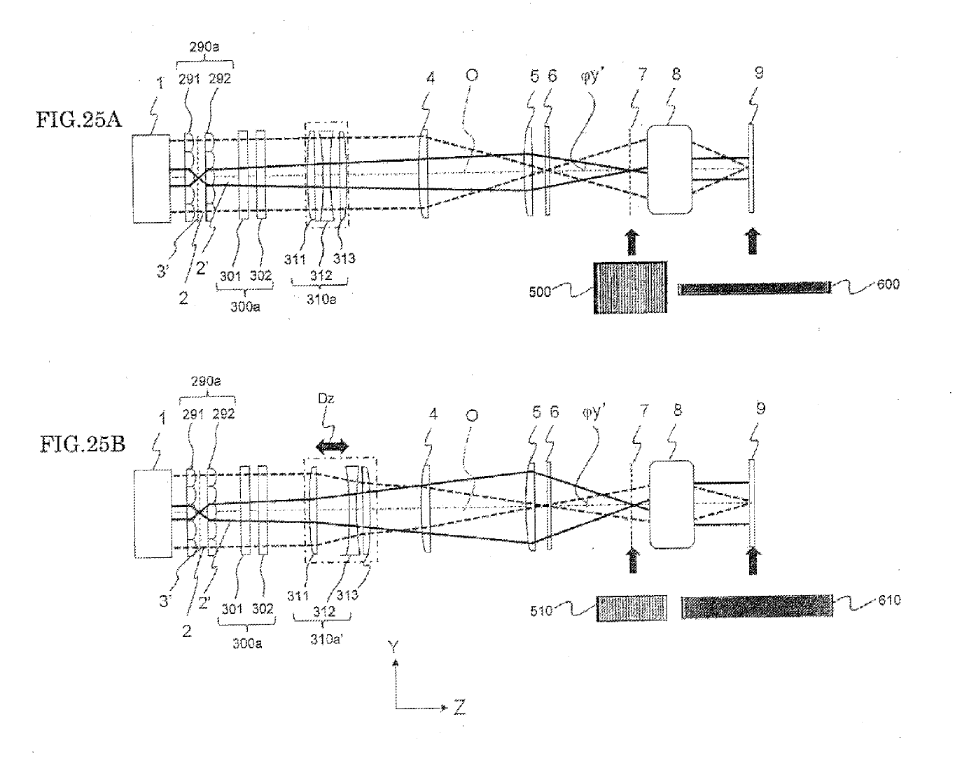

FIGS. 25A and 25B are explanatory views (YZ section) showing an illumination size on an entrance pupil plane when the beam size is changed in Example 13. FIG. 25A shows an illumination optical system with a reference beam size and an illumination size on an entrance pupil plane thereof. FIG. 25B shows the illumination optical system with a changed beam size and an illumination size on the entrance pupil plane.

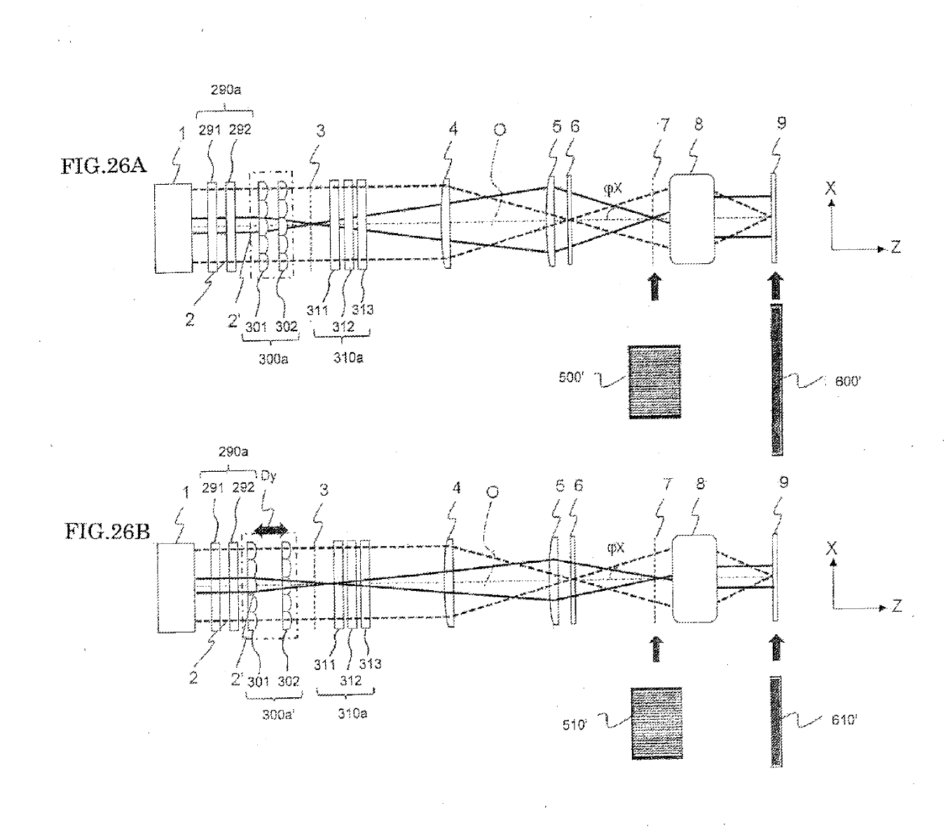

FIGS. 26A and 26B are explanatory views (XZ section) showing an illumination size on the entrance pupil plane when the beam size is changed in Example 13. FIG. 26A shows the illumination optical system with the reference beam size and an illumination size on the entrance pupil plane. FIG. 26B shows the illumination optical system with a changed beam size and an illumination size on the entrance pupil plane.

For example, assume that a beam size 600, 610 on the projection surface is changed in each direction as shown in FIGS. 25A and 25B and FIGS. 26A and 26B. In this case, the lens interval of a cylindrical telescope lens group 310a (cylindrical telescope lens 311, 312 and 313) is changed for the beam size in the short axis direction, and the lens interval of a cylindrical array lens group 300a (cylindrical array lens 301 and 302) is changed for the beam size in the long axis direction.

On this occasion, the lens interval of the short-axis-direction cylindrical telescope lens group 310a is changed to change the short-axis-direction beam size 600, 610. Then, the short-axis-direction illumination size 500, 510 on the entrance pupil plane 7 is also changed. This is caused by the kind of lenses whose lens interval Daa is changed. When a lens interval Dz of the short-axis-direction cylindrical telescope lens group 310a′ is changed; rays 2 are bent before and after the change as shown by the broken lines in FIGS. 25A and 25B.

From the aforementioned description, when the lens interval Dz is changed using the short-axis-direction cylindrical telescope lens group 310a′ to change the short-axis-direction beam size 600, 610 on the projection surface, it is necessary to control the short-axis-direction illumination size 500, 510 on the entrance pupil plane 7 independently of the short-axis-direction beam size 600, 610. This control is made to adjust the taper of a machined section in the short-axis-direction beam size 600, 610 on the projection surface.

Here, the machined section taper (resolving power in the beam size 600, 610 on the projection surface) depends on the ratio of the short-axis-direction illumination size on the entrance pupil plane 7 to the beam size on the projection lens 8. For example, assume that the short-axis-direction beams size 600, 610 on the projection surface is doubled by the short-axis-direction cylindrical telescope lens group 310a′, as shown in FIGS. 25A and 25B. In this case, the short-axis-direction illumination size 500, 510 on the entrance pupil plane 7 is reduced to half. Thus, the resolving power of the short-axis-direction beam size 600, 610 on the projection surface is increased. On the other hand, when the short-axis-direction beams size 600, 610 on the projection surface is reduced to half, the short-axis-direction illumination size 500, 510 on the entrance pupil plane 7 is doubled. Thus, the resolving power of the short-axis-direction beam size 600, 610 on the projection surface is decreased.

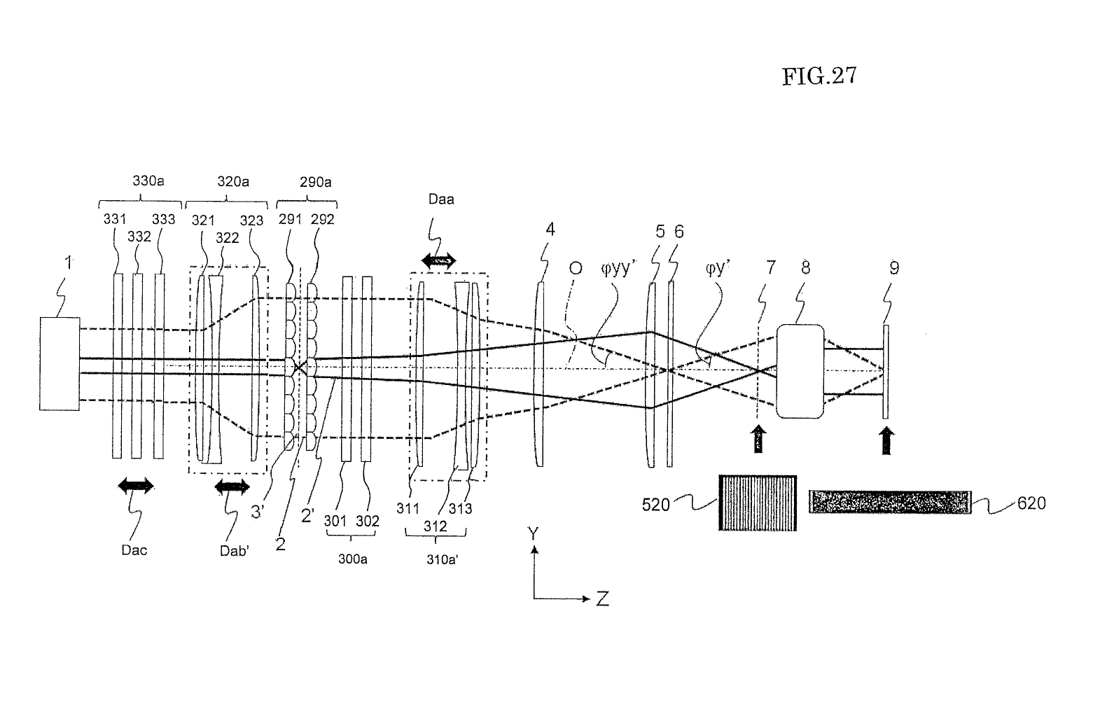

Therefore, in order to set the resolving power of the short-axis-direction beam size 610 on the projection surface to be lower than in FIG. 25B, a short-axis-direction collimator lens group 330a (collimator lenses 331, 332 and 333) need to be disposed at the rear of the light source 1 to change a lens interval Dac as shown in FIG. 27. Here, when a short-axis-direction illumination size 520 on the entrance pupil plane 7 is controlled desirably and continuously, a short-axis-direction collimator lens group 320a (collimator lenses 321, 322 and 323) may be constituted by three or more collimator lenses. When the short-axis-direction illumination size 520 on the entrance pupil plane 7 is used as a fixed size, the short-axis-direction collimator lens group 320a may be arranged by two or more collimator lenses fixed to obtain an optimum light source size.

With this configuration, an aperture angle φyy′ of illumination light with respect to a mask surface 6 is changed so that the illumination size 520 on the entrance pupil plane 7 of the projection lens 8 can be changed desirably in the short axis direction.

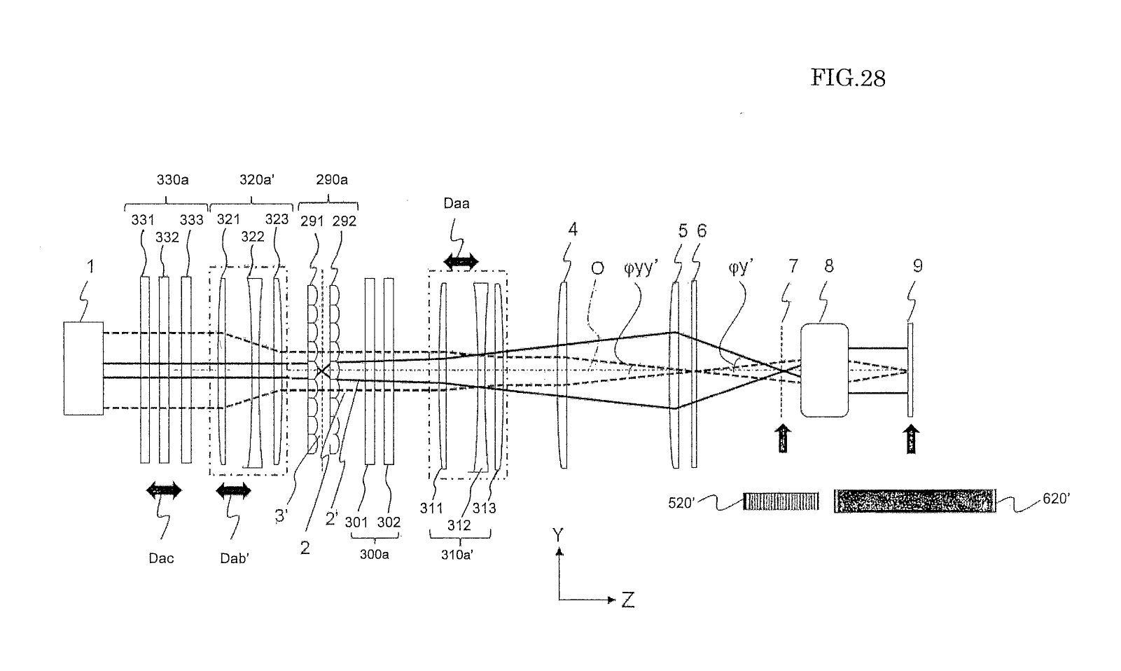

Further, in order to set the resolving power of the long-axis-direction beam size 620 on the projection surface to be higher than in FIG. 25B, a short-axis-direction collimator lens group 320a need to be disposed at the rear of the light source 1 to change a lens interval Dab′ as shown in FIG. 28. Thus, the aperture angle φyy′ of the illumination light with respect to the mask surface 6 is changed so that the illumination size 520′ on the entrance pupil plane 7 of the projection lens 8 can be changed desirably in the short axis direction.

On the other hand, even when the lens interval of the long-axis-direction cylindrical array lens group 300a is changed to change the beam size in the long axis direction as shown in FIGS. 26A and 26B, there is no change in the long-axis-direction illumination size on the entrance pupil plane 7. This is caused by the kind of lenses whose lens interval is changed. When a lens interval Dy of the long-axis-direction cylindrical array lens group 300a′ is changed, there is no change in rays 2 before and after the change as shown by the solid lines in FIGS. 26A and 26B. This is because the parallel light 2 from the light source 1 becomes chief rays of each cylindrical array lens.

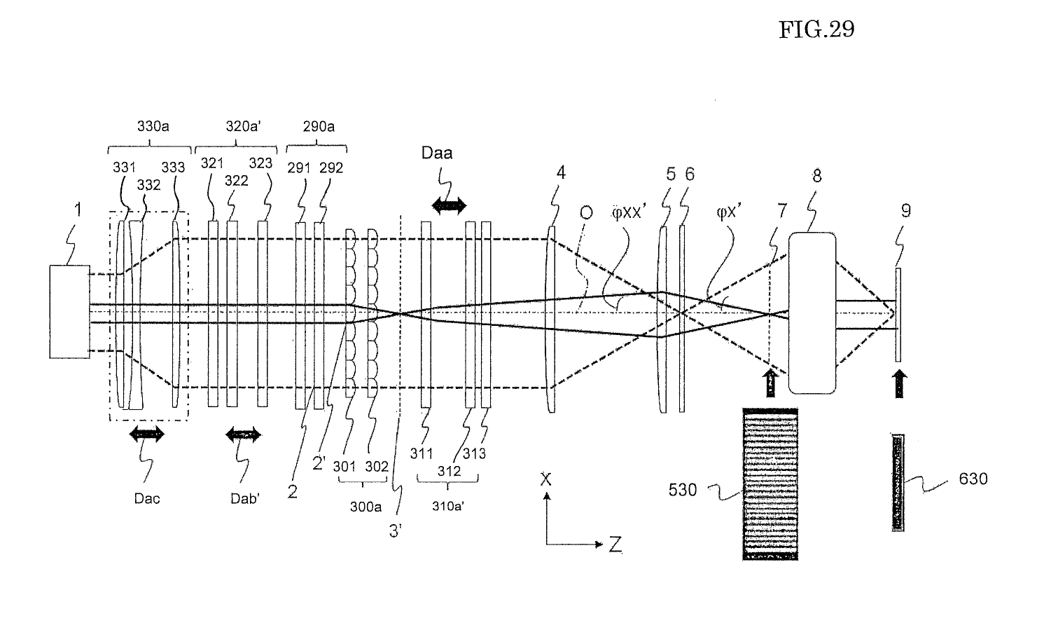

Therefore, in order to set the resolving power of the long-axis-direction beam size 630 on the projection surface to be lower than in FIG. 26B while leaving the long-axis-direction beam size on the projection surface as it is, the long-axis-direction collimator lens group 330a need to be disposed at the rear of the light source 1 to change the lens interval Dac as shown in FIG. 29. Here, when a long-axis-direction illumination size 530 on the entrance pupil plane 7 is controlled desirably and continuously independently of the long-axis-direction beam size 630 on the projection surface, the long-axis-direction collimator lens group 330a may be constituted by three or more collimator lenses. When the long-axis-direction illumination size 530 on the entrance pupil plane 7 is used as a fixed size, the long-axis-direction collimator lens group 330a may be arranged by two or more collimator lenses fixed to obtain an optimum light source size.

The reference numeral 290a represents a short-axis-direction cylindrical array lens group, which includes cylindrical array lenses 291 and 292.

With this configuration, an aperture angle φxx′ of the illumination light with respect to the mask surface 6 is changed so that the illumination size 530 on the entrance pupil plane 7 of the projection lens 8 can be changed desirably in the long axis direction.

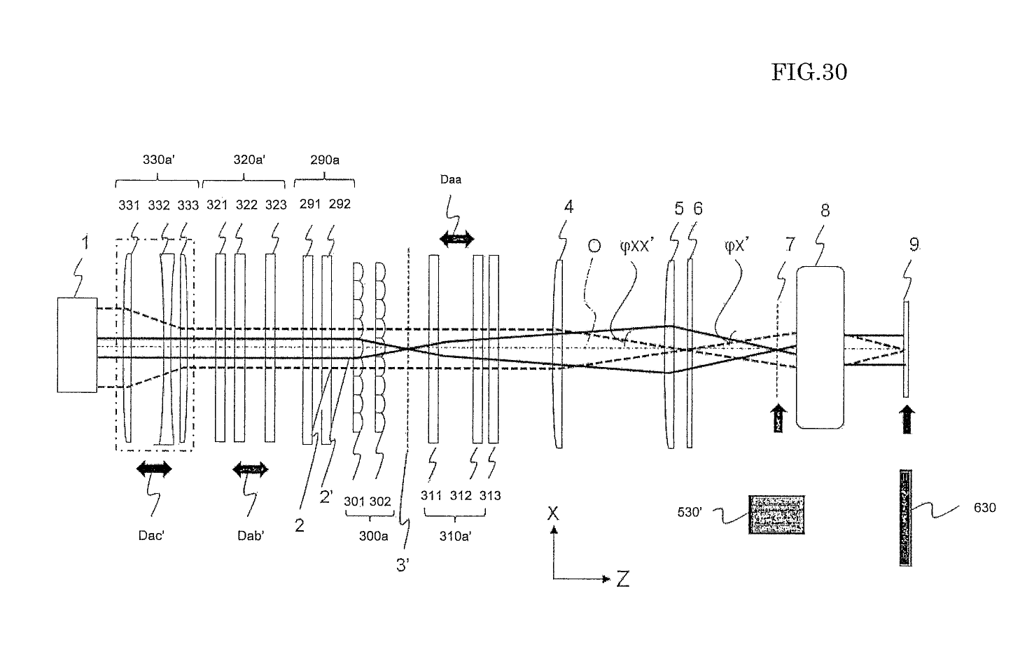

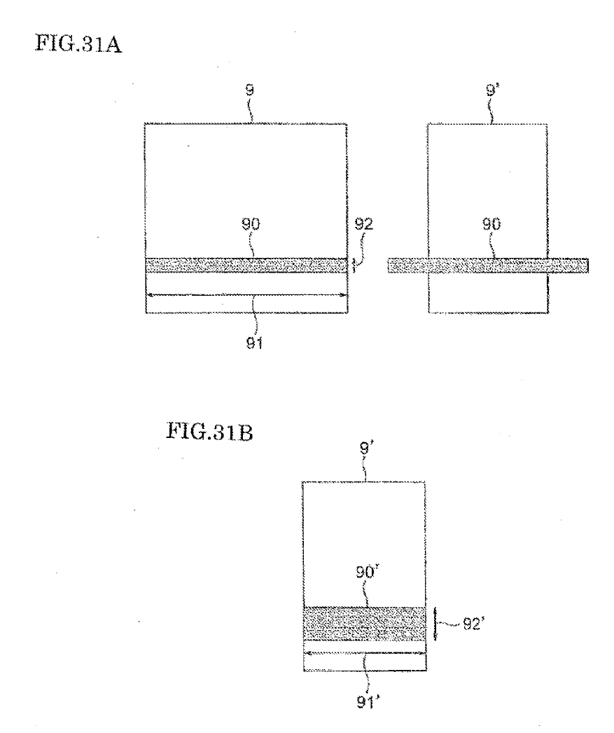

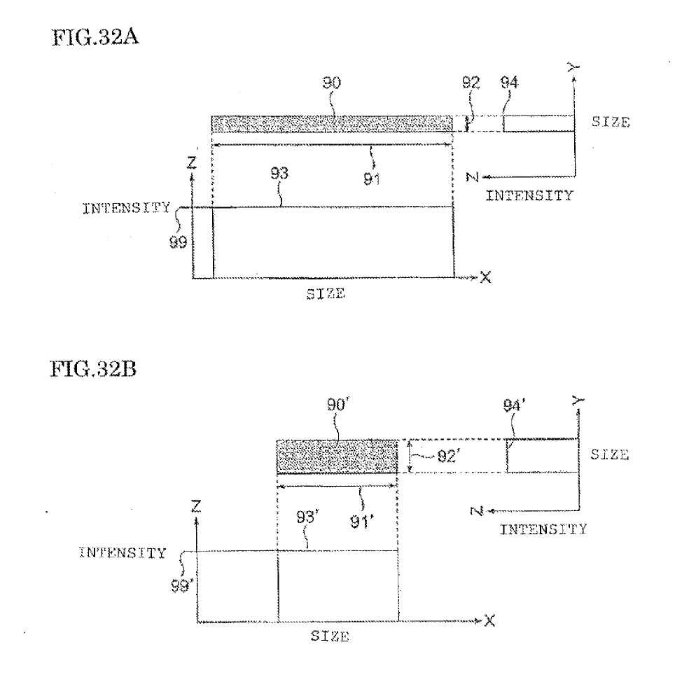

Further, in order to set the resolving power of the long-axis-direction beam size 630 on the projection surface to be higher than in FIG. 26B, the short-axis-direction collimator lens group 330a need to be disposed at the rear of the light source 1 to change the lens interval Dab′ as shown in FIG. 30. Thus, the aperture angle φxx′ of the illumination light with respect to the mask surface 6 is changed so that the illumination size 530′ on the entrance pupil plane 7 of the projection lens 8 can be changed desirably in the long axis direction.

Although this Example has been described in the configuration where a collimator lens group is built in Example 1, similar effect can be expected in a configuration where the collimator lens group is built in any other Example described herein.

As described above, according to this embodiment, effects can be obtained as:

1) Due to the beam size variable in the long axis direction, it is possible to support various package sizes without causing any energy loss.
2) Due to the slit width expanded in the short axis direction (scanning direction), it is possible to increase the cumulative amount of light, improve the machining speed and improve the throughput.
3) Due to the beam size variable in the long axis direction and the short axis direction, it is possible to perform machining on the same conditions. As a result, it is possible to reduce a variation in machining.
4) Since cylindrical array lenses fixed in one of the long axis direction and the short axis direction is used for varying the beam size in the long axis direction and the short axis direction, the optical axes of the cylindrical array lenses can be adjusted at only one place, so that the apparatus can be constructed by a simple optical system.
5) The number of optical parts required for changing the beam size in the long axis direction and the short axis direction can be reduced as compared with the case where three cylindrical telescope lenses are used for changing the beam size in each of the long axis direction and the short axis direction. Thus, the influence of aberration can be reduced.
6) When each of the numbers of long-axis-direction cylindrical array lenses and short-axis-direction cylindrical array lenses whose curvature radii are small is increased from one to two, the curvature radii can be increased to improve easiness in manufacturing.
7) When two cylindrical array lenses in the long axis direction and the short axis direction are used, it is possible to suppress the spread of light during long-distance propagation.
8) Due to cylindrical array lenses used in the long axis direction and the short axis direction, it is possible to form a plurality of secondary light sources so that it is possible to obtain a uniform intensity distribution on a projection surface.
9) Due to a long- (or short-) axis-direction collimator lens group disposed behind a light source, the light source size can be changed so that constant or desired resolving power can be obtained in any projection pattern in the long and short axis directions.
10) It is possible to control the beam size on a machined portion and the illumination size on an entrance pupil plane independently of each other.

The invention is not limited to the embodiment, but various modification can be made. All the technical items included in the technical thought of the invention stated in the scope of claims are intended by the invention.

What is claimed is:

1. An adjustable beam size illumination optical apparatus comprising:
a light source which generates parallel light;
a beam size adjusting optical system which includes lenses or lens groups disposed correspondingly to a long axis direction and a short axis direction respectively and having fixed or variable intervals among the lenses, and adjusts the parallel light from the light source in size in accordance with the two axis directions orthogonal to each other;
a condenser lens by which a plurality of pieces of light from secondary light source images formed by the lenses or the lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the beam size adjusting optical system changes one of the lens intervals among the lenses or the lens groups to adjust a beam size on the projection surface in accordance with the long axis direction or the short axis direction.

2. An adjustable beam size illumination optical apparatus according to claim 1, further comprising:
a light source size adjusting optical system which includes a collimator lens group disposed on an optical path of the parallel light to adjust the light source in size in accordance with the long axis direction and the short axis direction independently while adjusting the parallel light from the light source in size in accordance with the two axis directions orthogonal to each other; wherein:
the light source size adjusting optical system uses the collimator lens group to change an aperture angle of illumination light with respect to a mask surface to adjust an illumination size in an entrance pupil plane of the projection lens in accordance with the long axis direction and the short axis direction individually.

3. An adjustable beam size illumination optical apparatus, comprising:
a light source which generates parallel light;
a beam size adjusting optical system which includes groups of cylindrical array lenses disposed correspondingly to a long axis direction and a short axis direction respectively and having variable intervals among the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the beam size adjusting optical system changes the lens interval of one of the cylindrical array lens groups and the cylindrical telescope lens group to adjust a beam size on the projection surface in accordance with the long axis direction or the short axis direction.

4. An adjustable beam size illumination optical apparatus according to claim 3, wherein:
of the cylindrical array lens groups, a cylindrical array lens group in a direction in which the beam size can be changed includes at least two cylindrical array lenses, and a cylindrical array lens group in a direction in which the beam size cannot be changed includes at least one cylindrical array lens.

5. An adjustable beam size illumination optical apparatus, comprising:
a light source which generates parallel light;
a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other;
a beam size adjusting optical system which includes groups of cylindrical array lenses disposed correspondingly to the long axis direction and the short axis direction respectively and having variable intervals among the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the light source size adjusting optical system uses the collimator lens group to adjust the light source in size to adjust an illumination size in the entrance pupil plane of the projection lens in accordance with the long axis direction and the short axis direction individually; and
the beam size adjusting optical system changes the lens interval of one of the cylindrical array lens groups and the cylindrical telescope lens group to adjust a beam size on the projection surface in accordance with the long axis direction or the short axis direction.

6. An adjustable beam size illumination optical apparatus according to claim 5, wherein:
the collimator lens group includes three or more collimator lenses in each of the long axis direction and the short axis direction so that the lens intervals can be changed to make the light source variable in size in accordance with the long axis direction and the short axis direction independently of each other.

7. An adjustable beam size illumination optical apparatus according to claim 5, wherein:
the collimator lens group includes two or more fixed collimator lenses in each of the long axis direction and the short axis direction so as to optimize the light source in size to use the light source in a fixed size.

8. An adjustable beam size illumination optical apparatus comprising:
a light source which forms parallel light;
a beam size adjusting optical system which includes groups of cylindrical array lenses disposed correspondingly to a long axis direction and a short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the beam size adjusting optical system changes the lens interval of one of the cylindrical array lens groups to adjust a beam size on the projection surface in accordance with the long axis direction or the short axis direction.

9. An adjustable beam size illumination optical apparatus according to claim 8, wherein:
the beam size adjusting optical system includes a cylindrical array lens group for changing the beam size in the long axis direction, and a cylindrical array lens group for changing the beam size in the short axis direction; and
each of the cylindrical array lens groups for changing the beam size in the long axis direction and the short axis direction respectively includes two or three cylindrical array lenses.

10. An adjustable beam size illumination optical apparatus, comprising:
a light source which generates parallel light;
a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other;
a beam size adjusting optical system which includes groups of cylindrical array lenses disposed correspondingly to the long axis direction and the short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the light source size adjusting optical system uses the collimator lens group to adjust the light source in size to adjust an illumination size in the entrance pupil plane of the projection lens in accordance with the long axis direction and the short axis direction individually; and
the beam size adjusting optical system changes the lens interval of one of the cylindrical array lens groups to change a beam size on the projection surface in accordance with the long axis direction or the short axis direction.

11. An adjustable beam size illumination optical apparatus according to claim 10, wherein:
the collimator lens group includes three or more collimator lenses in each of the long axis direction and the short axis direction so that the lens intervals can be changed to make the light source variable in size in accordance with the long axis direction and the short axis direction independently of each other.

12. An adjustable beam size illumination optical apparatus according to claim 10, wherein:
the collimator lens group includes two or more fixed collimator lenses in each of the long axis direction and the short axis direction so as to optimize the light source in size to use the light source in a fixed size.

13. An adjustable beam size illumination optical apparatus, comprising:
a light source which forms parallel light;
a beam size adjusting optical system which includes groups of cylindrical array lenses disposed correspondingly to a long axis direction and a short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the beam size adjusting optical system changes the lens interval of one of the cylindrical telescope lens groups to adjust a beam size on the projection surface in accordance with the long axis direction or the short axis direction.

14. An adjustable beam size illumination optical apparatus according to claim 13, wherein:
the cylindrical telescope lens groups include three cylindrical telescope lenses in the long axis direction and the short axis direction respectively; and
the cylindrical array lens groups include one or more cylindrical array lenses in the long axis direction and the short axis direction respectively.

15. An adjustable beam size illumination optical apparatus, comprising:
a light source which generates parallel light;
a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other;
a beam size adjusting optical system which includes groups of cylindrical array lenses disposed correspondingly to the long axis direction and the short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface;
a field lens by which secondary light source images formed from the parallel light from the light source are reshaped on an entrance pupil plane of a projection lens; and
a projection surface on which an image of the irradiated surface is formed by the field lens; wherein:
the light source size adjusting optical system uses the collimator lens group to adjust the light source in size to adjust an illumination size in the entrance pupil plane of the projection lens in accordance with the long axis direction and the short axis direction individually; and
the beam size adjusting optical system changes the lens interval of one of the cylindrical telescope lens groups to change a beam size on the projection surface in accordance with the long axis direction or the short axis direction.

16. An adjustable beam size illumination optical apparatus according to claim 15, wherein:
the collimator lens group includes three or more collimator lenses in each of the long axis direction and the short axis direction so that the lens intervals can be changed to make the light source variable in size in accordance with the long axis direction and the short axis direction independently of each other.

17. An adjustable beam size illumination optical apparatus according to claim 15, wherein:
the collimator lens group includes two or more fixed collimator lenses in each of the long axis direction and the short axis direction so as to optimize the light source in size to use the light source in a fixed size.

18. An adjustable beam size method in an illumination optical apparatus including:
a light source which generates parallel light;
a beam size adjusting optical system which includes lenses or lens groups disposed correspondingly to a long axis direction and a short axis direction respectively and having fixed or variable intervals among the lenses, and adjusts the parallel light from the light source in size in accordance with the two axis directions orthogonal to each other;
a condenser lens by which a plurality of pieces of light from secondary light source images formed by the lenses or the lens groups are condensed and superposed on an irradiated surface; and
a field lens by which secondary light source images formed from the parallel light from the light source are reshaped on an entrance pupil plane of a projection lens;
the beam size adjusting method comprising the step of:
changing the lens intervals of the lenses or the lens groups to change an aperture angle of illumination light with respect to the entrance pupil plane of the projection lens so that a beam size of light projected on the projection surface where an image of the irradiated surface is formed can be changed in accordance with the long axis direction and the short axis direction individually.

19. An adjustable beam size method according to claim 18, the illumination optical apparatus further including a light source size adjusting optical system which includes a collimator lens group disposed on an optical path of the parallel light to adjust the light source in size in accordance with the long axis direction and the short axis direction independently of each other while adjusting the parallel light from the light source in size in accordance with the two axis directions orthogonal to each other, the method further comprising the step of: allowing the light source size adjusting optical system to use the collimator lens group to change an aperture angle of illumination light with respect to a mask surface to adjust an illumination size in the entrance pupil plane of the projection lens in accordance with the long axis direction and the short axis direction individually.

20. An adjustable beam size method in an illumination optical apparatus including:
a light source which generates parallel light;
a beam size adjusting optical system which includes groups of cylindrical array lenses disposed correspondingly to a long axis direction and a short axis direction respectively and having variable intervals among the lenses, and a group of cylindrical telescope lenses disposed correspondingly to one of the long axis direction and the short axis direction and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface; and
a field lens by which secondary light source images formed from the parallel light from the light source are reshaped on an entrance pupil plane of a projection lens;
the beam size adjusting method comprising the step of:
changing the lens interval of one of the cylindrical array lens groups and the cylindrical telescope lens group to change an aperture angle of illumination light with respect to the entrance pupil plane of the projection lens so that a beam size of light projected on the projection surface where an image of the irradiated surface is formed can be changed in accordance with the long axis direction or the short axis direction.

21. An adjustable beam size method in an illumination optical apparatus including:
a light source which generates parallel light;
a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other;
a beam size adjusting optical system which includes groups of cylindrical array lenses disposed correspondingly to the long axis direction and the short axis direction respectively and having variable intervals among the lenses, and a group of cylindrical telescope lenses disposed correspondingly to one of the long axis direction and the short axis direction and having variable intervals among the lenses, and changes the parallel light from the light source in size in accordance with the two axis directions orthogonal to each other;
a condenser lens by which a plurality of pieces of light from secondary light source images formed by the cylindrical array lens groups are condensed and superposed on an irradiated surface; and
a field lens by which secondary light source images formed from the parallel light from the light source are reshaped on an entrance pupil plane of a projection lens;
the beam size adjusting method comprising the steps of:
allowing the light source size adjusting optical system to use the collimator lens group to change an aperture angle of illumination light with respect to a mask surface so as to adjust an illumination size in the entrance pupil plane of the projection lens in accordance with the long axis direction and the short axis direction individually; and
allowing the beam size adjusting optical system to change the lens interval of one of the cylindrical array lens groups and the cylindrical telescope lens group to change the aperture angle of the illumination light with respect to the entrance pupil plane of the projection lens so that a beam size of light projected on the projection surface where an image of the irradiated surface is formed is changed in accordance with the long axis direction or the short axis direction.

22. An adjustable beam size method in an illumination optical apparatus including:
a light source which generates parallel light;
a beam size adjusting optical system which includes groups of cylindrical array lenses disposed correspondingly to a long axis direction and a short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface; and
a field lens by which secondary light source images formed from the parallel light from the light source are reshaped on an entrance pupil plane of a projection lens;
the beam size adjusting method comprising the step of:
changing the lens intervals of the cylindrical array lens groups to change an aperture angle of illumination light with respect to the entrance pupil plane of the projection lens so that a beam size of light projected on the projection surface where an image of the irradiated surface is formed is changed in accordance with the long axis direction or the short axis direction.

23. An adjustable beam size method in an illumination optical apparatus including:
a light source which generates parallel light;
a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other;
a beam size adjusting optical system which includes groups of cylindrical array lenses disposed correspondingly to the long axis direction and the short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface; and
a field lens by which secondary light source images formed from the parallel light from the light source are reshaped on an entrance pupil plane of a projection lens;
the beam size adjusting method comprising the steps of:
allowing the light source size adjusting optical system to use the collimator lens group to change an aperture angle of illumination light with respect to a mask surface so as to adjust an illumination size in the entrance pupil plane of the projection lens in accordance with the long axis direction and the short axis direction individually; and
allowing the beam size adjusting optical system to change the lens interval of one of the cylindrical array lens groups to change the aperture angle of the illumination light with respect to the entrance pupil plane of the projection lens so that a beam size of light projected on the projection surface where an image of the irradiated surface is formed is changed in accordance with the long axis direction or the short axis direction.

24. A beam size adjusting method in an illumination optical apparatus including:
a light source which generates parallel light;
a beam size adjusting optical system which includes groups of cylindrical array lenses disposed correspondingly to a long axis direction and a short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface; and
a field lens by which secondary light source images formed from the parallel light from the light source are reshaped on an entrance pupil plane of a projection lens;
the beam size adjusting method comprising the step of:
changing the lens interval of one of the cylindrical telescope lens groups to change an aperture angle of illumination light with respect to the entrance pupil plane of the projection lens so that a beam size of light projected on the projection surface where an image of the irradiated surface is formed can be changed in accordance with the long axis direction or the short axis direction.

25. An adjustable beam size method in an illumination optical apparatus including:
a light source which generates parallel light;
a light source size adjusting optical system which includes a collimator lens group disposed on an optical path of the parallel light to adjust the light source in size in accordance with a long axis direction and a short axis direction independently of each other while adjusting the parallel light from the light source in size in accordance with the two axis directions orthogonal to each other;
a beam size adjusting optical system which includes groups of cylindrical array lenses disposed correspondingly to the long axis direction and the short axis direction respectively and having fixed intervals among the lenses, and groups of cylindrical telescope lenses disposed correspondingly to the long axis direction and the short axis direction respectively and having variable intervals among the lenses, and adjusts the parallel light from the light source in size in accordance with the two axis directions orthogonal to each other;
a condenser lens by which a plurality of pieces of light from secondary light source images formed by the cylindrical array lens groups are condensed and superposed on an irradiated surface; and
a field lens by which secondary light source images formed from the parallel light from the light source are reshaped on an entrance pupil plane of a projection lens;
the beam size adjusting method comprising the steps of:
allowing the light source size adjusting optical system to use the collimator lens group to change an aperture angle of illumination light with respect to a mask surface so as to adjust an illumination size in the entrance pupil plane of the projection lens in accordance with the long axis direction and the short axis direction individually; and
allowing the beam size adjusting optical system to change the lens interval of one of the cylindrical telescope lens groups to change the aperture angle of the illumination light with respect to the entrance pupil plane of the projection lens so that a beam size of light projected on the projection surface where an image of the irradiated surface is formed is changed in accordance with the long axis direction or the short axis direction.
